(19) United States
(12) Patent Application Publication
(10) Pub. No.: US 2026/0177534 A1
(43) Pub. Date: Jun. 25, 2026

(54) AUTO IDENTIFICATION OF ANALYTES IN ION CHROMATOGRAPHY

(71) Applicant: Dionex Corporation, Sunnyvale, CA (US)

(72) Inventors: Akinde Florence Kadjo, Palo Alto, CA (US); Sai Smruti Samantaray, Sunnyvale, CA (US)

(21) Appl. No.: 18/999,121

(22) Filed: Dec. 23, 2024

(51) Int. Cl. G01N 30/86

(52) U.S. Cl. CPC G01N 30/8693; G01N 30/8679; G01N 30/8696

(57) ABSTRACT

Embodiments described herein relate to analysis of chromatography data. A system can comprise a memory that stores, and a processor that executes, computer executable components. The computer executable components can comprise a comparing component, of an analytical model, that executes a comparison, of a target characteristic of a target analyte to a first known characteristic of a first known analyte, the first known characteristic comprising a deviation relative to a second known characteristic of a second known analyte, and an identifying component, of the analytical model, that executes an identification, of the target analyte, corresponding to a target peak of a target chromatogram, which target chromatogram corresponds to target analyte chromatography data, based on the comparison.

### BACKGROUND

Identification of aspects of chromatography data from one or more chemical structure measurement instruments can be a complicated and time-intensive process. One or more variables of different columns, different instruments, different elution times, different analyte concentrations, etc. can affect ability to accurately and/or efficiently conduct the identification and/or comparison. Indeed, such one or more variables can cause false positive and/or false negative identification, lack of accurate comparison, etc. In one or more other cases, execution of an identification can be wholly inefficient, based on manual examination of a large plurality of known analyte chromatography data.

### SUMMARY

The following presents a summary to provide a basic understanding of one or more example embodiments described herein. This summary is not intended to identify key or critical elements, and/or to delineate scope of particular embodiments or scope of claims. Its sole purpose is to present concepts in a simplified form as a prelude to the more detailed description that is presented later. In one or more example embodiments, systems, computer-implemented methods, apparatuses and/or computer program products described herein can provide a plug-and-play process for using data generated by a measurement instrument (also herein referred to as a measurement device) to calibrate, normalize and/or compare measurement instrument output data in a time efficient and automatic manner.

In accordance with an embodiment, a system can comprise a memory that stores computer executable components, and a processor that executes the computer executable components. The computer executable components can comprise a comparing component, of an analytical model, that executes a comparison, of a target characteristic of a target analyte to a first known characteristic of a first known analyte, the first known characteristic comprising a deviation relative to a second known characteristic of a second known analyte, and an identifying component, of the analytical model, that executes an identification, of the target analyte, corresponding to a target peak of a target chromatogram, which target chromatogram corresponds to target analyte chromatography data, based on the comparison.

In accordance with another embodiment, a computer-implemented method can comprise executing, by an analytical model of a system operatively coupled to a processor, a comparison, of a target characteristic of a target analyte to a first known characteristic of a first known analyte, the first known characteristic comprising a deviation relative to a second known characteristic of a second known analyte, and executing, by the analytical model of the system, an identification, of the target analyte, corresponding to a target peak of a target chromatogram, which target chromatogram corresponds to target analyte chromatography data, based on the comparison.

In accordance with another embodiment, a computer program product, facilitating a process for chromatogram peak identification, can comprise a computer readable storage medium having program instructions embodied therewith. The program instructions can be executable by a processor to cause the processor to execute, by the processor using an analytical model, a comparison, of a target characteristic of a target analyte to a first known characteristic of a first known analyte, the first known characteristic comprising a deviation relative to a second known characteristic of a second known analyte, and execute, by the processor, using the analytical model, an identification, of the target analyte, corresponding to a target peak of a target chromatogram, which target chromatogram corresponds to target analyte chromatography data, based on the comparison.

The one or more example embodiments described herein can be implemented within, in connection with and/or coupled to a chemical structure measurement instrument, such as a scientific measurement instrument, such as a chromatography instrument.

The one or more example embodiments disclosed herein can be applied on a plug-and-play basis to a measurement instrument, plural measurement instrument, a same measurement instrument using plural exchangeable components (e.g., columns), etc. for calibration, normalization and/or comparison of output data relative to unknown, known and/or standard analyte chromatography data. As used herein, known analyte chromatography data can comprise and/or be standard analyte chromatography data. The frameworks described herein can be performed in a time efficient and at least partially automatic manner, thereby increasing device use time and/or reducing user entity interaction for pre-experiment and/or post-experiment processes. In one or more cases, identification data obtained from use of the one or more example embodiments can be employed to construct a database of known analyte chromatography data.

The one or more example embodiments described herein can be employed to employ deviations of characteristics among known analyte chromatography datasets. These deviations can be caused by different instruments, different columns, different elution times, aging of a column, different analyte concentrations, etc., without being limited thereto. The characteristics that can be exhibited due to the deviations can be of the chromatography data that resolve as characteristics of a chromatogram generated from the chromatography data. For example, a characteristic can comprise a shift in a peak along an x-axis (elution time axis), a shift in a peak along a y-axis (conductivity axis), a shift in a shape of a peak, a change in a range of elution time, etc. Deviations can be employed indirectly, such as training one or more neurons and/or layers of an analytical model on known analyte chromatography data comprising deviations and/or deviation characteristics, in connection with one or more peak identities and/or peak characteristics of the known analyte chromatography data.

Moreover, based on the comparison, a more comprehensive understanding of the target analyte chromatography data can be obtained, as compared to existing frameworks. For example, the one or more example embodiments described herein can employ the one or more deviations to compare peaks of target analyte chromatography data to corresponding peaks of known analyte chromatography data, such as in view of prior training of one or more neurons and/or layers of an artificial intelligence model on such various deviations and associated correlations to peak identities and/or peak characteristics.. This can enable identification of target peaks and thus a target analyte of the target analyte chromatography data even in view of variations of different target analyte chromatography datasets for a same target analyte. These identifications can be accomplished employing a database of hundreds, thousands, tens of thousands, or more known analyte chromatography datasets, labeled peaks, etc., without being limited thereto, upon which the one or more analytical models can trained and/or employ.

In one or more cases, one or more embodiments described herein can indirectly employ the one or more deviations, as described above, to identify target peaks of target analytes relative to/using corresponding peaks of known analyte chromatography data. For example, an identification can be employed to accurately verify quality of a product, accurately determine a location to drill, and/or accurately purchase chemical recipe components, even in view of variations of different target analyte chromatography datasets for a same target analyte.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 illustrates a block diagram of an example, non-limiting system that can facilitate a process for chromatography data comparison, in accordance with one or more example embodiments described herein.

FIG. 2 illustrates a block diagram of still another example, non-limiting system that can facilitate a process for chromatography data comparison, in accordance with one or more example embodiments described herein.

FIG. 3 illustrates an example chromatogram, in accordance with one or more example embodiments described herein.

FIG. 4 illustrates a set of example chromatograms, including chromatogram shift caused by column-to-column variation, in accordance with one or more example embodiments described herein.

FIG. 5 illustrates a set of example chromatograms, including chromatogram shift caused by instrument to instrument variation, in accordance with one or more example embodiments described herein.

FIG. 6 illustrates a set of example chromatograms, including chromatogram shift caused by time elapsing, in accordance with one or more example embodiments described herein.

FIG. 7 illustrates a set of example chromatograms, including chromatogram shift caused by different analyte concentrations, in accordance with one or more example embodiments described herein.

FIG. 8A illustrates a flow diagram of training and execution processes that can be performed by the non-limiting system of FIG. 2, in accordance with one or more example embodiments described herein.

FIG. 8B illustrates a distribution of analytes employed for data sets used for generation of the graphs of FIGS. 4 to 7, in accordance with one or more example embodiments described herein.

FIG. 8C illustrates an example process flow for data processing that can be employed by the non-limiting system of FIG. 2, in accordance with one or more example embodiments described herein.

FIG. 9 illustrates a flow diagram of one or more processes that can be performed by the non-limiting system of FIG. 1, in accordance with one or more example embodiments described herein.

FIG. 10 illustrates another flow diagram of one or more processes that can be performed by the non-limiting system of FIG. 2, in accordance with one or more example embodiments described herein.

FIG. 11 illustrates a continuation of the flow diagram of FIG. 10 of one or more processes that can be performed by the non-limiting system of FIG. 2, in accordance with one or more example embodiments described herein.

FIG. 12 illustrates a block diagram of an example operating environment into which embodiments of the subject matter described herein can be incorporated.

FIG. 13 illustrates an example schematic block diagram of a computing environment with which the subject matter described herein can interact and/or be implemented at least in part.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section.

Turning first to the subject of chemical structure measurement instruments generally, such measurement instruments can comprise, but are not limited to spectrometry devices, chromatography devices, etc. Output from such devices can be measurement data defining intensities, mass-to-charge ratios, analyte conductivities, precursors and/or analytes analyzed during analysis.

One such type of measurement data can be chromatography data resulting from operation of a chromatography device. Chromatography is an analytical technique used for separating molecules of analytes in a mixture. In liquid chromatography, a particular type of chromatography, one or more analytes can be identified based on a time the analytes exit a separator, referred to as retention time and/or elution time. However, a given retention time often cannot be used to universally confirm identify of a peak due to a shifting nature of the peak at varying measurements. This shifting can be undesirably addressed by continued reestablishment of the retention time-to-identity relationship through the injection of known analytes, such as standards analytes.

That is, in the chromatographic process, the analytes travel through a column propelled by a mobile phase while interacting with a stationary phase. Separation is accomplished due to the differing affinities of the analytes for the stationary phase vs. the mobile phase. As the analytes exit the column, their presence is captured by a detector placed downstream from the column, the resulting trace is the chromatogram. An analyte's retention time is specific to a nature of the analyte, hence its use for identification.

For ion chromatography (IC), another type of chromatography, which is specific to the separation of anions and cations, a suppressor can be used prior to a conductivity detector to enhance an analyte's signals prior to detection.

An existing practice can be to first separate a standard mixture of the known and desired analytes, often referred to as standards, under optimum conditions, such as a given eluent concentration, a set flow rate, a set temperature, etc. Then the sample containing target analytes can be injected under the same conditions. Identification of the target sample's analytes can be based on a comparison of the retention time of the peaks in the target sample chromatogram vs those of the known injected standards. A target analyte's peak having the same retention time as that of a particular known analyte can be identified as that particular analyte.

However, an issue can be that analyte retention times can and do shift. For example, retention time can be impacted by a variety of reasons such as a column itself (e.g., variation within the same column type), the aging of a column, the instrument, the suppressor, the analyte concentration etc. Accordingly, relying only on retention time for identification can lead to errors.

Another issue can be that a user entity desires to inject a set of known analytes (e.g., standards) for analysis before each batch of target samples to analyze. This initial step is often done and/or executed starting up the instrument after a period of non-use, after a period of time (e.g., a few days) due to aging of an associated column, or anytime a component within the flow path is replaced (e.g., eluent, column, piece of tubing, valves, suppressor, etc.).

It is noted that mass spectrometers can additionally and/or alternatively be employed, however use of such instruments can be expensive, time consuming, and/or employ high levels expertise for minimal operations.

Accordingly, to allow for comparison of chromatography data from different analysis runs, plural compounds and/or plural devices, and/or against one or more known (e.g., standardized) datasets, it can be advantageous to employ a baseline for such comparison. Such baseline can comprise use of known (e.g., standard) analyte chromatography datasets. However, this can be tedious, inefficient, and time consuming, in view of comparison to hundreds, thousands or more known analyte chromatography datasets.

Further, as noted above, simple comparison can generally fail due to chromatogram shift in target analyte chromatography data as compared to known analyte chromatography data. That is, a shift can be comprised by a deviation, which shift can be caused by use of different instruments, different columns, different elution times, aging of a column (even over days), different analyte concentrations, etc., without being limited thereto. That is, the resulting comparable chromatography data of at least one sample can exhibit a deviation relative to chromatography data of another sample (e.g., of the same target analyte). Characteristics that can be exhibited due to the deviations can be characteristics of the chromatography data that resolve as characteristics of a chromatogram generated from the chromatography data. For example, a characteristic can comprise a shift in a peak along an x-axis (elution time axis), a shift in a peak along a y-axis (conductivity axis), shift in a shape of a peak, change in range of elution time, etc.

Accordingly, differences between output target analyte chromatography datasets from use of a same target analyte can result in high difficulty in conducting the aforementioned comparison, thus resulting in failure to identify analytes eluted, false positive identification and/or false negative identification.

To account for one or more of these deficiencies, the one or more embodiments described herein can provide a process for employing learned deviation characteristics relative to different instruments, column types, time lapses, analyte concentrations, etc. to compare target analyte chromatography data and known analyte chromatography data (and/or one or more patterns having been learned from the known analyte chromatography data). This can result in identification of peaks, and/or eluted analytes corresponding to such peaks, with reduced and/or eliminated identification error. That is false positive identifications, false negative identifications and/or other incorrect or failed identifications can be reduced and/or prevented.

Further, identification of peaks can be based on one or more factors other than elution time and/or retention time, different from existing frameworks. Instead, identification of peaks using the one or more embodiments described herein can be based on one or more other considerations, including instrument type, column type, analyte concentration, and/or column life cycle, and/or a combination thereof, based on training that is based one or more shifts caused by one or more deviations.

To provide such results, a database of analyte standard chromatography data can be analyzed to provide comparison of one or more datasets comprised by the analyte standard chromatography data to target analyte chromatography data, in view of the recognized one or more deviation characteristics.

That is, there can be one or more intrinsic markers within the trace of a peak that can correlate to an analyte's identity. In one or more cases, an analytical model, such as an artificial intelligence (AI) and/or machine learning (ML) model, can be employed to recognize and/or employ a hidden pattern based on these one or more intrinsic markers. That is, one or more embodiments described herein can employ one or more such models. For example, for a given column type or for a given column type-set condition combination, the model can provide the identity of an analyte.

An analytical model employed herein can comprise any one or more types of model including, but not limited to, a neural network, directed neural network, convoluted neural network, k-nearest neighbors classifier, language model, gradient boosting, logistic regression, scikit-learn (sklearn) and/or sklearn gradient boosting.

For example, analytes separated with a given column type (e.g., comprising a set size and set length) and set processing conditions can be manually and/or automatically identified based on an analytical model. In one or more cases, an analytical model can be built for a given column type or other particular chromatography instrument specification. That is, an analytical model can be trained to acquire learned analyte, peak and/or chromatography data patterns relative to such given column type or other particular chromatography instrument specification, for example.

For example, an analytical model can be employed to generally determine how target analyte chromatography data differs from known analyte chromatography data, such as based on one or more deviations comprised by the known analyte chromatography data. In one or more cases, the analytical model can be trained on a plurality of different deviations and/or characteristics thereof. In one or more cases, the analytical model can identify a peak and/or analyte corresponding to a peak of the target analyte chromatography data based on one or more differences and/or particular deviations learned relative to plural known analyte chromatography data sets, and can label and save chromatography data corresponding to the identification.

In one or more cases, the analytical model can generate a reasoning for a particular identification of the peak based on identification of a learned and/or recognized pattern that is based on training with training chromatography data comprising a plurality of different deviations (e.g., indirect use of the one or more deviations). In one or more cases, the model can notify a user entity of the reasoning behind an identification to allow for any subsequent evaluation and/or remediation. As a result, a comprehensive understanding of the target analyte chromatography data and its variables can be obtained. This can allow for not only comparison, but also calibration, lifecycle tracking, etc. of a chromatography instrument, column, etc.

As used herein, the term “analyte” can refer to a compound comprising one or more ions, which analyte can be eluted from a precursor using chromatography techniques performed by a chromatography instrument.

As used herein, the phrase “based on” should be understood to mean “based at least in part on,” unless otherwise specified.

As used herein, the term “compound” can refer to a single material, multiple materials, composition, sample, solution, product, etc.

As used herein, the term “data” can comprise metadata.

As used herein, the terms “entity,” “requesting entity,” and “user entity” can refer to a machine, instrument, device, component, hardware, software, smart device, party, organization, individual and/or human.

One or more example embodiments are now described with reference to the drawings, where like referenced numerals are used to refer to like drawing elements throughout. In the following description, for purposes of explanation, numerous specific details are set forth in order to provide a more thorough understanding of the one or more example embodiments. It is evident in various cases, however, that the one or more example embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

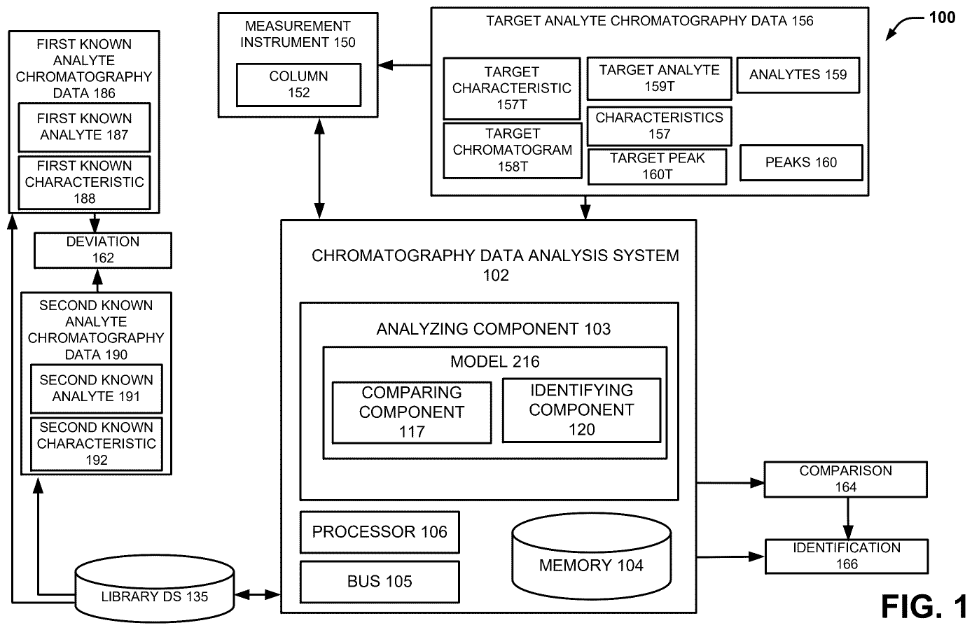

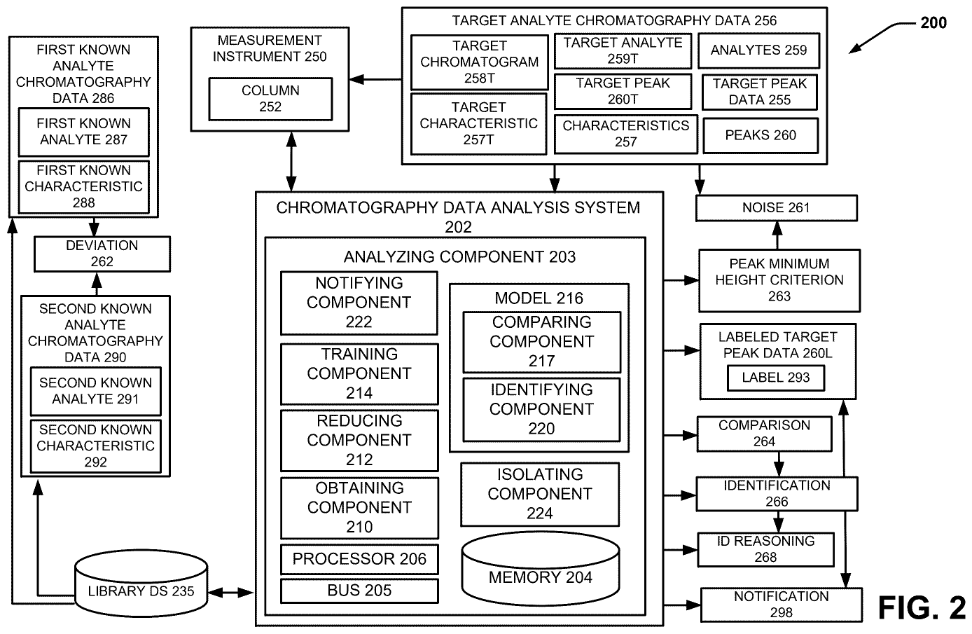

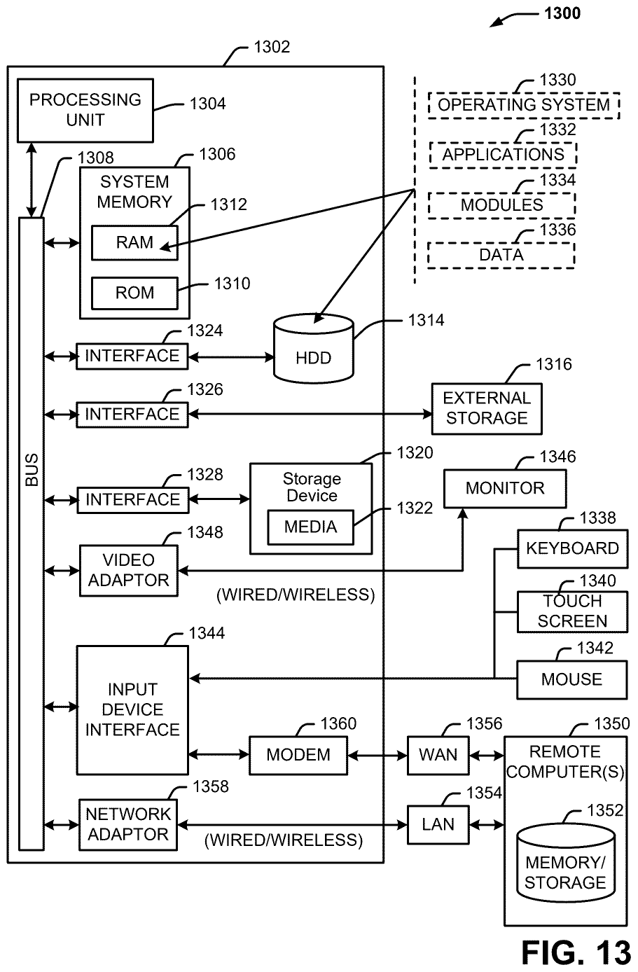

Referring now to FIGS. 1 and 2, in one or more example embodiments, the non-limiting systems 100 and/or 200 illustrated at FIGS. 1 and 2, and/or systems thereof, can further comprise one or more computer and/or computing-based elements described herein with reference to a computing environment, such as the computing environment 1300 illustrated at FIG. 13. In one or more described embodiments, computer and/or computing-based elements can be used in connection with implementing one or more of the systems, devices, components and/or computer-implemented operations shown and/or described in connection with FIGS. 1 and/or 2 and/or with other figures described herein.

Turning first to FIG. 1, the figure illustrates a block diagram of an example, non-limiting system 100 that can comprise a chromatography data analysis system 102 and a library datastore (DS) 135. Optionally, the non-limiting system 100 can comprise a measurement instrument 150 (e.g., a chromatography instrument or other scientific measurement instrument). In one or more other embodiments, the measurement instrument 150 and/or library datastore 135 can be located external to the chromatography data analysis system 102 which can be communicatively coupled to the measurement instrument 150 and/or library datastore 135.

It is noted that the chromatography data analysis system 102 is only briefly detailed to provide but a lead-in to a more complex and/or more expansive chromatography data analysis system 202 as illustrated at FIG. 2. That is, further detail regarding processes that can be performed by one or more example embodiments described herein will be provided below relative to the non-limiting system 200 of FIG. 2.

Still referring to FIG. 1, the chromatography data analysis system 102 can generally facilitate analysis of analytes based on differences between characteristics of known analyte chromatography data 286, 290 and the target analyte chromatography data 256.

As used herein, target analyte chromatography data 156 can be data comprising one or more unknowns for which identification of one or more analytes 159 corresponding to one or more peaks 160 in the data is desired.

As used herein, known analyte chromatography data 186, 190 can be data that is known, standardized, etc., comprising known peaks corresponding to known analytes 187, 191.

As used herein, a characteristic 157, 188, 192 can comprise, but is not limited to, a shift in a peak along an x-axis (elution time axis), a shift in a peak along a y-axis (conductivity axis), shift in a shape of a peak, change in range of elution time, etc.

The chromatography data analysis system 102 can comprise at least a memory 104, bus 105, processor 106, analytical model, comparing component 117 and/or identifying component 120. The processor 106 can be the same as the processor 1304 (FIG. 13), comprised by the processor 1304 or different therefrom. The memory 104 can be the same as the system memory 1306 (FIG. 13), comprised by the system memory 1306 or different therefrom.

As illustrated, the analytical model 116 can comprise the comparing component 117 and/or identifying component 120. In one or more other embodiments, one or both of the comparing component 117 and identifying component 120 can be separate from (e.g., other than comprised by) the analytical model 116.

Using the above-noted components, the chromatography data analysis system 102 can facilitate a process to execute one or more comparisons 164 of chromatography data 156, 186, 190, resulting in generation of one or more identifications 166 of one or more analytes 159 defined by target analyte chromatography data 156. This can be accomplished regardless of one or more various differences exhibited by (e.g., comprised by) the target analyte chromatography data 156 relative to the known analyte chromatography data 186, 190.

While only first known analyte chromatography data 186 and second known analyte chromatography data 190 are illustrated as being employed by the chromatography data analysis system 102, it is appreciated that any one or more other known analyte chromatography datasets can be employed by the chromatography data analysis system 102 and/or comprised by the library datastore 135.

Generally, the comparing component 117 can execute a comparison of a target characteristic 157T of the target analyte chromatography data 156 to a first known characteristic 188 of first known analyte chromatography data 186/of a first known analyte 187.

The first known characteristic 188 can comprise a deviation 162 relative to a second known characteristic 192 of a second known analyte 191.

As noted above, a deviation 162 can comprise a shift in at least a portion of the respective analyte chromatography data, relative to another analyte chromatography data, which shift can be caused by use of different instruments, different columns, different elution times, aging of a column (even over days), different analyte concentrations, etc., without being limited thereto. As also noted above, a characteristic 157, 188, 192 can comprise, but is not limited to, a shift in a peak along an x-axis (elution time axis), a shift in a peak along a y-axis (conductivity axis), shift in a shape of a peak, change in range of elution time, etc.

In one or more cases, the identifying component 120, and/or the processor 106, can make a determination of whether the comparison 164 has been executed.

The identifying component 120 can generally execute an identification 166 of the target analyte 159T, corresponding to a target peak 160T of a target chromatogram 158T, which target chromatogram 158T corresponds to the target analyte chromatography data 156, based on the comparison 164.

It is noted that in any case, generation of the target chromatogram 158T need not be performed directly and also need not be displayed for a user entity. Indeed, peaks 160, including a target peak 160T for which the identification 166 of the target analyte 159T is desired, can be evaluated based on non-graphed target analyte chromatography data 156.

The analytical model 116 can be and/or comprise a machine learning model and/or analytical model of any suitable type.

The analytical model 116, comparing component 117 and/or identifying component 120 can be operatively coupled to the processor 106 which can be operatively coupled to the memory 104. The bus 105 can provide for the operative coupling. The processor 106 can facilitate execution of the analytical model 116, comparing component 117 and/or identifying component 120. The analytical model 116, comparing component 117 and/or identifying component 120 can be stored at the memory 104.

In general, the non-limiting system 100 can employ any suitable method of communication (e.g., electronic, communicative, internet, infrared, fiber, etc.) to provide communication between the chromatography data analysis system 102 and/or any instrument associated with a user entity, such as the measurement instrument 150, such as a spectrometry instrument.

It is noted that one or more additional measurement instruments likewise can be communicatively couplable with the non-limiting system 100 and/or comprised by the non-limiting system 100. For example, a first measurement instrument 150 can have performed chromatography analysis on a first compound using a first column 152, and a second measurement instrument 150 can have performed chromatography analysis on the first compound or a second compound using the first column 152 or another column 152.

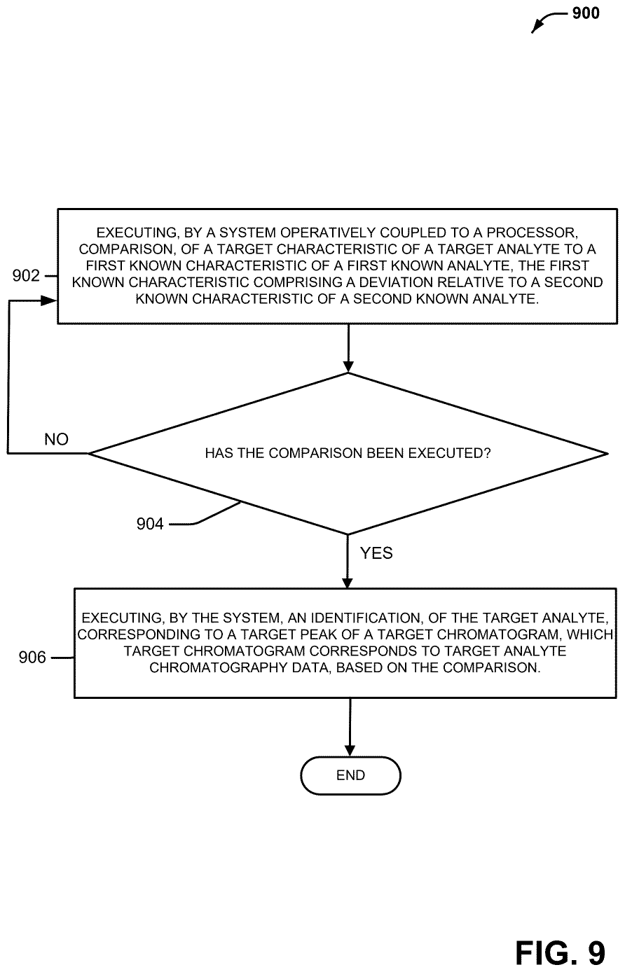

As a summary of the above-described components and functions thereof, referring next only briefly to FIG. 9, illustrated is a flow diagram of an example, non-limiting method 900 that can facilitate a process to compare analyte chromatography data, in accordance with one or more example embodiments described herein, such as the non-limiting system 100 of FIG. 1. While the non-limiting method 90 is described relative to the non-limiting system 100 of FIG. 1, the non-limiting method 900 can be applicable also to other systems described herein, such as the non-limiting system 200 of FIG. 2. Repetitive description of like elements and/or processes employed in respective embodiments is omitted for sake of brevity.

At 902, the non-limiting method 900 can comprise executing, by a system (e.g., comparing component 117 of the analytical model 116), a comparison (e.g., comparison 164) of a target characteristic (e.g., target characteristic 157T) of a target analyte (e.g., target analyte 159T) to a first known characteristic (e.g., first known characteristic 188) of a first known analyte (e.g., first known analyte 187), the first known characteristic comprising a deviation (e.g., deviation 162) relative to a second known characteristic (e.g., second known characteristic 192) of a second known analyte (e.g., second known analyte 191).

At 904, the non-limiting method 900 can comprise determining, by the system (e.g., identifying component 120 and/or processor 106), whether the comparison has been executed. If yes, the non-limiting method 900 can proceed to step 906. If not, the non-limiting method 900 can proceed back to step 902.

At 906, the non-limiting method 900 can comprise executing, by the system (e.g., identifying component 120 of the analytical model 116) an identification (e.g., identification 166), of the target analyte, corresponding to a target peak (e.g., target peak 160T) of a target chromatogram (e.g., target chromatogram 158T), which target chromatogram corresponds to target analyte chromatography data (e.g., target analyte chromatography data 156), based on the comparison.

Turning next to FIG. 2, a non-limiting system 200 is illustrated that can comprise a chromatography data analysis system 202, a measurement instrument 250 and a library datastore (DS) 235. Repetitive description of like elements and/or processes employed in respective embodiments is omitted for sake of brevity. Description relative to an embodiment of FIG. 1A and/or FIG. 1B can be applicable to an embodiment of FIG. 2. Likewise, description relative to an embodiment of FIG. 2 can be applicable to an embodiment of FIG. 1A and/or FIG. 1B.

In one or more embodiments, the measurement instrument 250, such as a chromatography instrument, can be separate from but communicatively couplable to the non-limiting system 200.

In one or more embodiments, one or more additional measurement instruments likewise can be communicatively couplable with the non-limiting system 200 and/or comprised by the non-limiting system 200. For example, a first measurement instrument 250 can have performed chromatography analysis on a first compound using a first column 252, and a second measurement instrument 250 can have performed chromatography analysis on the first compound or a second compound. For another example, a first measurement instrument 250 can have performed chromatography analysis on a first compound using a first column 252, and a second measurement instrument 250 can have performed chromatography analysis on the first compound or a second compound using the first column 252 or a second column 252.

In one or more embodiments, the library datastore 235 be separate from but communicatively couplable to the non-limiting system 200.

While only first known analyte chromatography data 286 and second known analyte chromatography data 290 are illustrated as being employed by the chromatography data analysis system 202, it is appreciated that any one or more other known analyte chromatography datasets can be employed by the chromatography data analysis system 202 and/or comprised by the library datastore 235.

Generally, the chromatography data analysis system 202 can facilitate analysis of a target analyte 259T of target analyte chromatography data 256.

As used herein, target analyte chromatography data 256 can be data comprising one or more unknowns for which identification of one or more analytes 259 corresponding to one or more peaks 260 (e.g., analyte peaks 260) of the target analyte chromatography data 256 is desired.

As used herein, known analyte chromatography data 286, 290 can be data that is known, standardized, etc., comprising peaks corresponding to known analytes 287, 291.

As used herein, a characteristic 257, 283 can comprise, but is not limited to, a shift in a peak along an x-axis (elution time axis), a shift in a peak along a y-axis (conductivity axis), shift in a shape of a peak, change in range of elution time, etc.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2(3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

The chromatography data analysis system 202 can be associated with, such as accessible via, a cloud computing environment, such as the cloud computing environment 1300 of FIG. 13.

The chromatography data analysis system 202 can comprise a plurality of components. The components can comprise a memory 204, processor 206, bus 205, obtaining component 210, reducing component 212, training component 214, analytical model 216, comparing component 217, identifying component 220, notifying component 222, and/or isolating component 224. Using these components, the chromatography data analysis system 202 can facilitate a process to generate one or more identifications 266 of one or more analytes 259 of target analyte chromatography data 256, even in view of variations of different target analyte chromatography datasets for a same target analyte. This can allow for analysis of unknown compounds by a measurement instrument 250.

Discussion next turns to the processor 206, memory 204 and bus 205 of the chromatography data analysis system 202. For example, in one or more example embodiments, the chromatography data analysis system 202 can comprise the processor 206 (e.g., computer processing unit, microprocessor, classical processor, quantum processor and/or like processor). In one or more example embodiments, a component associated with chromatography data analysis system 202, as described herein with or without reference to the one or more figures of the one or more example embodiments, can comprise one or more computer and/or machine readable, writable and/or executable components and/or instructions that can be executed by processor 206 to provide performance of one or more processes defined by such component and/or instruction. In one or more example embodiments, the processor 206 can comprise the obtaining component 210, reducing component 212, training component 214, analytical model 216, comparing component 217, identifying component 220, notifying component 222, and/or isolating component 224.

In one or more example embodiments, the chromatography data analysis system 202 can comprise the computer-readable memory 204 that can be operably connected to the processor 206. The memory 204 can store computer-executable instructions that, upon execution by the processor 206, can cause the processor 206 and/or one or more other components of the chromatography data analysis system 202 (e.g., obtaining component 210, reducing component 212, training component 214, analytical model 216, comparing component 217, identifying component 220, notifying component 222, and/or isolating component 224) to perform one or more actions. In one or more example embodiments, the memory 204 can store computer-executable components (e.g., obtaining component 210, reducing component 212, training component 214, analytical model 216, comparing component 217, identifying component 220, notifying component 222, and/or isolating component 224).

The chromatography data analysis system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more example embodiments, the chromatography data analysis system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more example embodiments, one or more of the components of the chromatography data analysis system 202 and/or of the non-limiting system 200 can reside in the cloud, and/or can reside locally in a local computing environment (e.g., at a specified location).

In addition to the processor 206 and/or memory 204 described above, the chromatography data analysis system 202 can comprise one or more computer and/or machine readable, writable and/or executable components and/or instructions that, when executed by processor 206, can provide performance of one or more operations defined by such component and/or instruction.

Discussion next turns to the additional components of the chromatography data analysis system 202 (e.g., obtaining component 210, reducing component 212, training component 214, analytical model 216, comparing component 217, identifying component 220, notifying component 222, and/or isolating component 224). As noted above, generally, the chromatography data analysis system 202 can facilitate a process to recognize and/or identify one or more analytes 259 corresponding to one or more peaks 260 of target analyte chromatography data 256 regardless of differences between and/or among instruments 250, columns 252, analyte concentrations, etc.

This process can be broken down into a set of processes including, but not limited to a first set of training an analytical model 216 using known analyte chromatography data 286, 290, a second set of executing of a comparison 264 using a trained analytical model 216, and a third set of executing of an identification 266 based on the comparison 264 and using the trained analytical model 216.

First, it is noted that in one or more example embodiments, the obtaining component 210, reducing component 212, training component 214, analytical model 216, comparing component 217, identifying component 220, notifying component 222, and/or isolating component 224 can be implemented independently, without one or more other of the obtaining component 210, reducing component 212, training component 214, analytical model 216, comparing component 217, identifying component 220, notifying component 222, and/or isolating component 224. Additionally and/or alternatively, the obtaining component 210, reducing component 212, training component 214, analytical model 216, comparing component 217, identifying component 220, notifying component 222, and/or isolating component 224 can be comprised by a high-level analyzing component 203, one or more of the below-described functions of the obtaining component 210, reducing component 212, training component 214, analytical model 216, comparing component 217, identifying component 220, notifying component 222, and/or isolating component 224 can be performed by the high-level analyzing component 203, and/or the obtaining component 210, reducing component 212, training component 214, analytical model 216, comparing component 217, identifying component 220, notifying component 222, and/or isolating component 224 can be omitted with the high-level analyzing component 203 performing one or more of the below-described functions of the one or more omitted obtaining component 210, reducing component 212, training component 214, analytical model 216, comparing component 217, identifying component 220, notifying component 222, and/or isolating component 224.

As noted above, a first set of one or more processes can comprise training a model 216 using known analyte chromatography data 286, 290 and/or additional known analyte chromatography data.

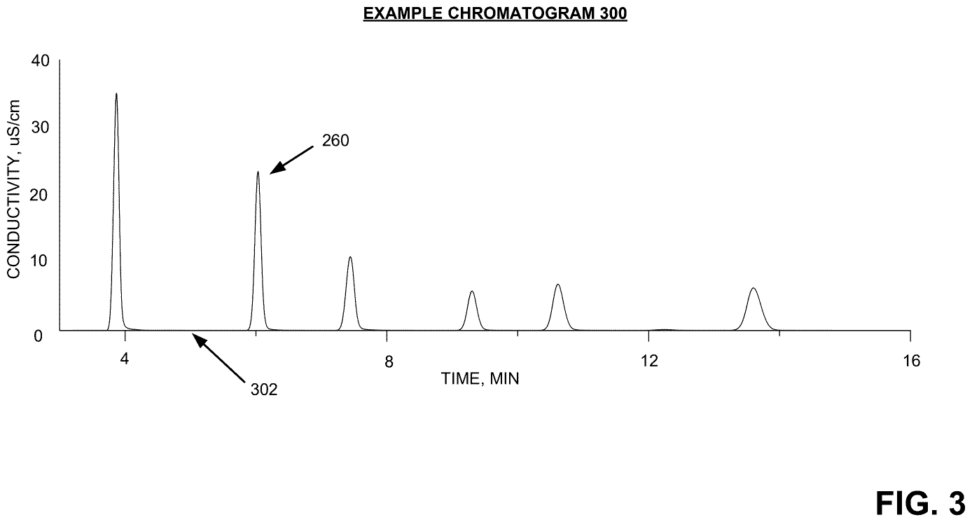

Accordingly, turning first to FIG. 3, chromatography data can generally comprise a set of data (e.g., data and/or metadata) in any suitable form. One or more chromatograms 300 can be generated by and/or defined by (e.g., without specific graphing thereof) the chromatography data. In one or more cases, chromatography data can comprise correspondences of time and conductivity. Time can be employed in any suitable unit, such as seconds, minutes, etc., without being limited thereto. Conductivity can be employed in any suitable units, such as μS/cm, without being limited thereto.

As illustrated graphically at FIG. 3 for ease of reference, a set of chromatography data can define one or more peaks 260 that can correspond to one or more analytes 259 having been eluted from an analyte or precursor. The analyte can have an initial concentration which can affect output of data and particularly the elution times (e.g., x-axis). Local minima 302 can comprise data points representing breaks between peaks 260.

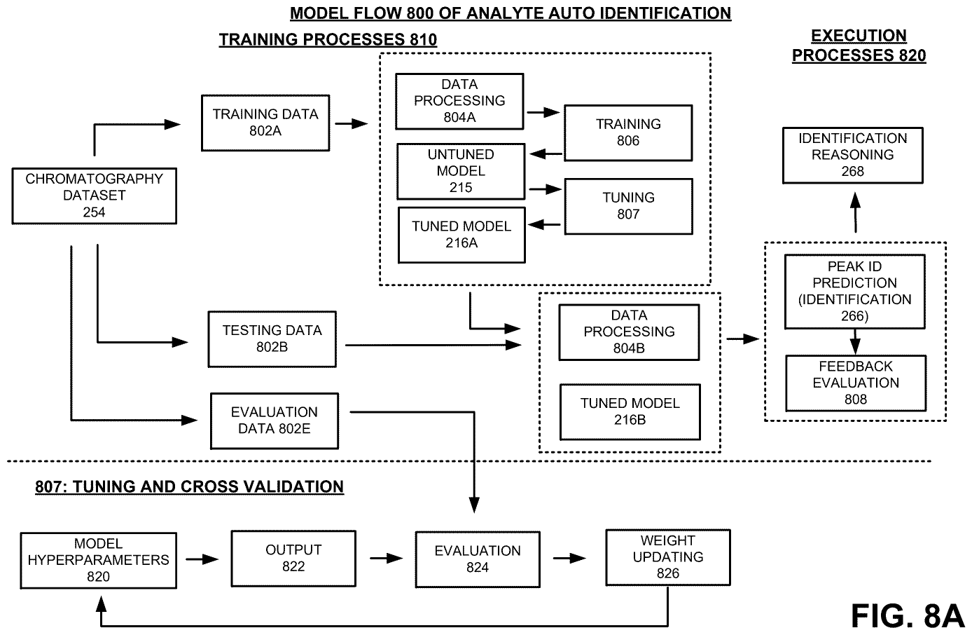

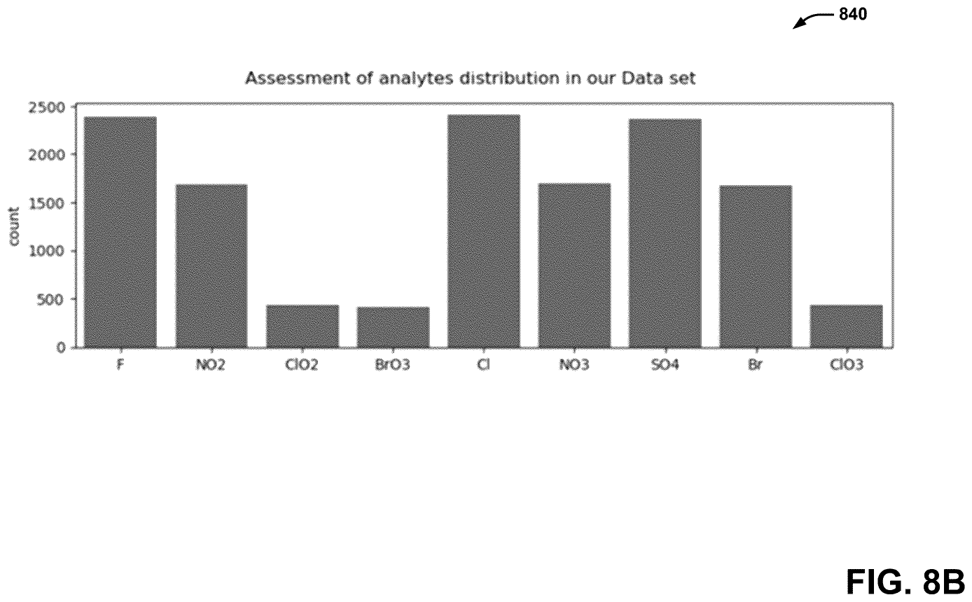

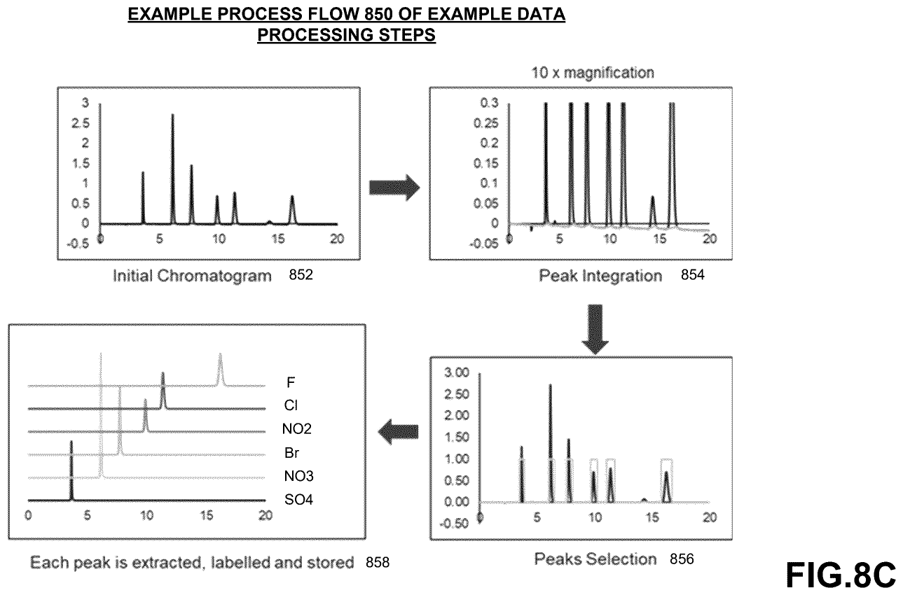

Turning now to the training component 214 of FIG. 2, and also to FIG. 8A, an analytical model 216 can be trained (e.g., training processes 810) on known analyte chromatography data 286, 290 to learn various deviations 262 exhibited as shifts in training chromatography data 802A of the known analyte chromatography data 286, 290. In one or more cases, the analytical model 216 can be trained on patterns of one or more deviations 262 and/or patterns of shifts comprised by a deviation 262 or comprised by multiple deviations.

Initial chromatography data can be obtained from any suitable source, such as the library database 235, which can comprise data (e.g., data and/or metadata) in any suitable form and/or language.

Initial chromatography data can comprise data using a plurality of one or more variables which can cause and/or define the different deviations 262. The variables can comprise, but are not limited to, data from different columns and/or column manufacturers, suppressors and/or suppressor manufacturers, instruments, usage variety, analytes, analyte concentrations, column lifecycles, etc. Analytes used can comprise, but are not limited to fluoride, chlorite, bromate, chloride, nitrite, chlorate, bromide, nitrate and/or sulfate.

For example, training data 802A and/or testing data 802B can be definitively and/or purposely varied data (e.g., using one or more of the above-noted variables), such as obtained for the purpose of training and/or obtained directly from various chromatography instruments 250 using various columns 252, various analyte concentrations and/or columns in various stages of use (e.g., various lifecycle phases thereof). In one or more cases, an initial set of data can be split into the training data 802A and testing data 802B (and/or, also, evaluation data 802E) using any suitable percentage split. For example, one non-limiting split can comprise about 76% training data 802A, about 12% evaluation data 802E and about 12% testing data 802B.

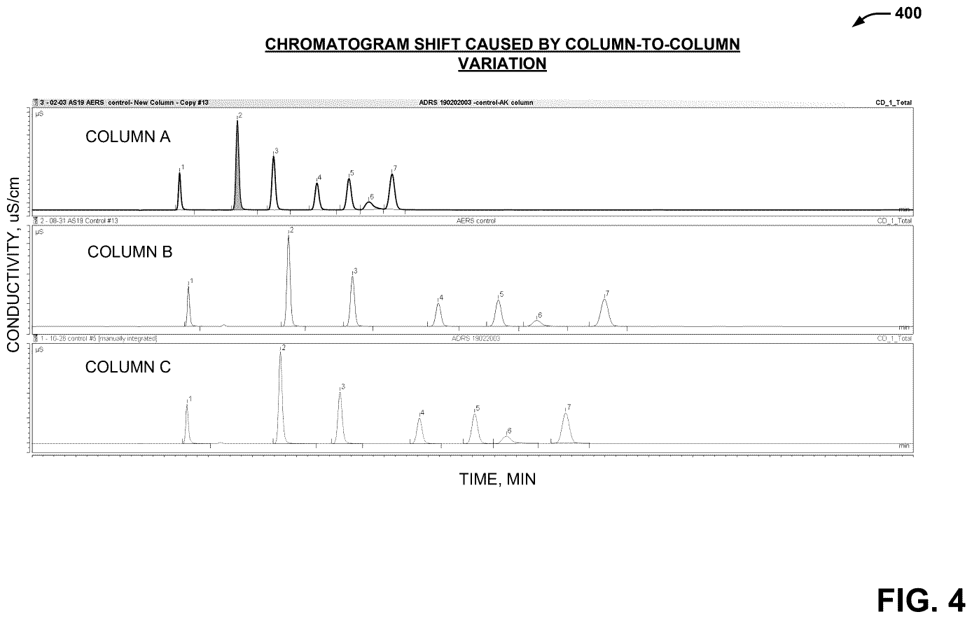

Turning next briefly to FIGS. 4 to 7, different known analyte chromatography datasets 286, 290 employed can exhibit one or more different deviations 262 to be identified and learned by an untrained/untuned analytical model 215, resulting in a trained/tuned analytical model 216 (e.g., 216A and/or 216B of FIG. 8A).

For example, FIG. 4 illustrates various graphs 400 visually demonstrating one or more shifts caused by column-to-column variation.

As illustrated, and without being limited to any particular specifications thereof, columns A, B and C are Ion Pac AS19 4 mm×250 4 μm (Part number 083217). Represented are separation conditions [EG Eluent: 20 mM KOH (0 to 20 min), Flow Rate: 1 ml/min, Injection Volume: 10 μL, Oven Temperature: 30° C., detector sampling rate: 5 Hz]. The set of anions separated using the same instrument are: 1. Fluoride, 2. Chloride, 3. Nitrite, 4. Bromide, 5. Nitrate, 6. Carbonate, 7. Sulfate, with the numbers representing the peaks in order from left to right. The slight differences in retention are more prominent for later eluting analytes (3 through 7).

That is, and again without being limited to any particular specifications thereof, column type used was Ion Pac AS19 4 mm×250 4 μm (Part number 083217). The column is a center of the separation since it contains the stationary phase. Although the manufacturing process in the production of columns can be streamlined, no columns are exactly the same due to the fact that they are packed with very fined resin particles, 4 μm diameter on average. In reality, the particle size distribution can vary from one column to the other, resulting in slight varieties in analytes separation. Therefore, there cannot be a standard column. For the same set of known analytes (e.g., standards) injected on three new columns upon initial installation, on the same instrument, the retention time of the known analytes are not exactly the same as illustrated at FIG. 4.

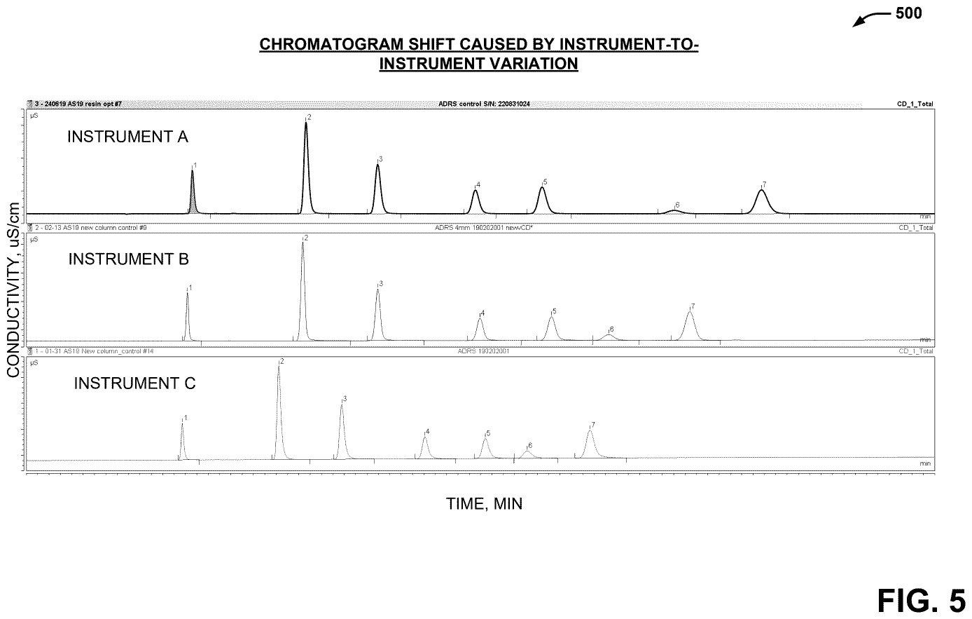

FIG. 5 illustrates various graphs 500 visually demonstrating one or more shifts caused by instrument-to-instrument variation, which can employ different columns 252, for example.

As illustrated, and without being limited to any particular specifications thereof, the columns of the instruments A, B and C employed were Ion Pac AS19 4 mm×250 mm 4 μm (Part number 083217). The separation conditions are [EG Eluent: 20 mM KOH (0 to 20 min), Flow Rate: 1 ml/min, Injection Volume: 10 μL, Oven Temperature: 30° C., detector sampling rate: 5 Hz]. The set of anions separated using different instruments are: 1. Fluoride, 2. Chloride, 3. Nitrite, 4. Bromide, 5. Nitrate, 6. Carbonate, 7. Sulfate, with the numbers representing the peaks in order from left to right. The slight differences in retention are more prominent for later eluting analytes.

That is, and again without being limited to any particular specifications thereof, instruments are generally not manufactured as exact equivalents to one another. This is a factor to consider as the end user entities would each be using different instruments. The instruments themselves are made up of several components including, but not limited to, pumps, eluent generators, degassers, several pieces of tubing, valves, suppressors, conductivity detectors, etc. Any variation in these components can be reflected in the final chromatogram. Therefore, for the same set of known analytes, a separation with the same column type and under the same run conditions, but different instruments, the resulting retention times can vary as illustrated at FIG. 5.

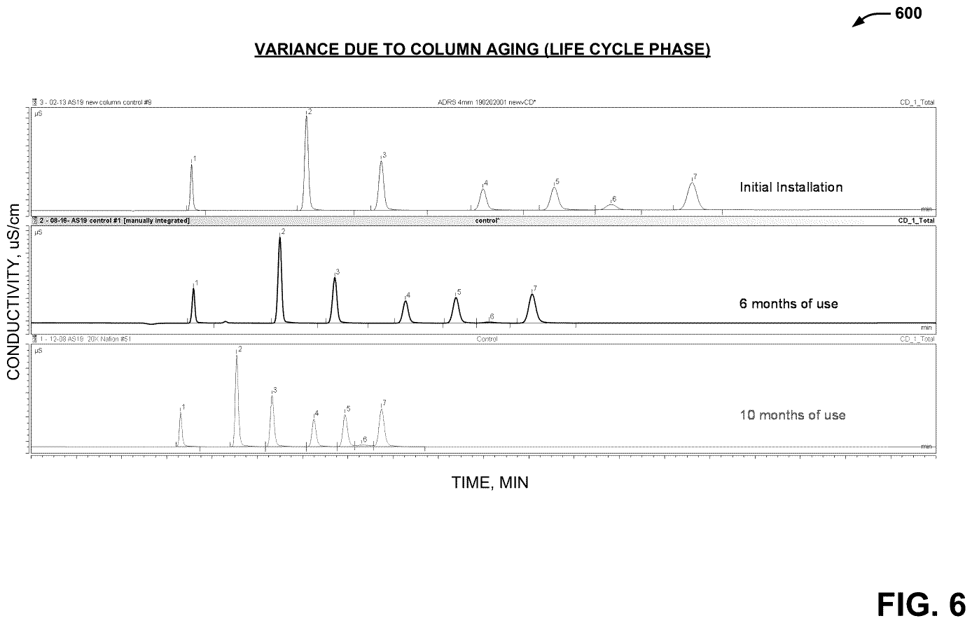

FIG. 6 illustrates various graphs 600 visually demonstrating one or more shifts caused by use of a column over time (e.g., different lifecycle phases of a single column, such as initial installation, 6 months of use and 10 months of use).

As illustrated, and without being limited to any particular specifications thereof, the three chromatograms illustrated are from the same column: Ion Pac AS19 4 mm×250 4 μm (Part number 083217). The separation conditions are [EG Eluent: 20 mM KOH (0 to 20 min), Flow Rate: 1 ml/min, Injection Volume: 10 μL, Oven Temperature: 30° C., detector sampling rate: 5 Hz]. The set of anions separated are: 1. Fluoride, 2. Chloride, 3. Nitrite, 4. Bromide, 5. Nitrate, 6. Carbonate, 7. Sulfate, with the numbers representing the peaks in order from left to right. The peaks elute faster and faster over time as the column slowly loses its efficiency over time.

That is, and again without being limited to any particular specifications thereof, the column contains the stationary phase. In ion chromatography, the stationary phase is made of small ion exchange particles. Upon initial installation, the column has a finite ion exchange capacity; which correlates to the column efficiency (e.g., often referred to as theoretical plate number). With continuous usage of the column, the column slowly loses its ability to separate analytes, and the analytes elute earlier and/or closer to one another. It is therefore expected for the retention time to get smaller as the column ages. FIG. 6 illustrates a set of 7 analytes injected on the same column, on the same instrument, from initial installation to 10 months of continuous use.

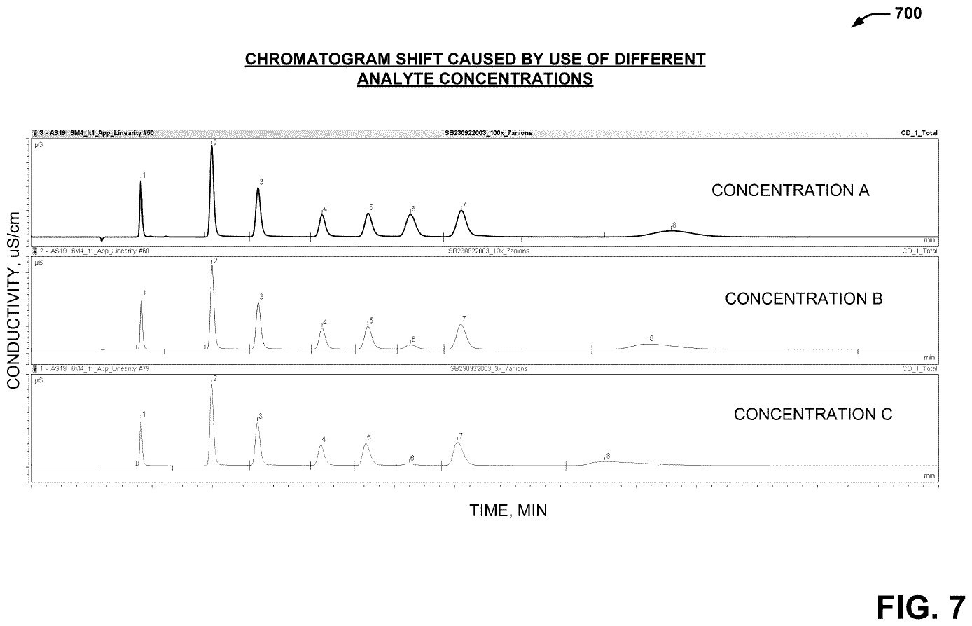

FIG. 7 illustrates various graphs 700 visually demonstrating one or more shifts caused by use of a same analyte at different concentrations. Concentration A is 100 times dilutions of a 7 anions standard I (P/N 056933). dilutions, with the corresponding y-axis ranging from 0.3 to 1.2 uS/cm. Concentration B is 10 times dilutions of a 7 anions standard I (P/N 056933), with the corresponding y-axis ranging from −1.0 to 9.0 uS/cm. Concentration C is 3 times dilutions of a 7 anions standard I (P/N 056933), with the corresponding y-axis ranging from −5.0 to 30.0 uS/cm.

As illustrated, and without being limited to any particular specifications thereof, the separation conditions are [EG Eluent: 20 mM KOH (0 to 20 min), Flow Rate: 1 ml/min, Injection Volume: 10 μL, Oven Temperature: 30° C., detector sampling rate: 5 Hz]. The set of anions separated using the same instrument are: 1. Fluoride, 2. Chloride, 3. Nitrite, 4. Bromide, 5. Nitrate, 6. Carbonate, 7. Sulfate, 8. Phosphate, with the numbers representing the peaks in order from left to right. From the top chromatogram to the bottom, the signal axis increases as the amount of analyte injected increases. For phosphate (analyte 8), a noticeable retention time shift is observed as the analyte's concentration increases.

That is, and again without being limited to any particular specifications thereof, chromatographic peak area or peak height are highly correlated to the analyte's concentration. It is therefore expected to observe an increase in signal intensity as a higher concentration of analyte is injected. However, in some occasions, when the injected analyte's concentration overwhelms the column's ion exchange capacity, a shift in the retention time can also be observed, as illustrated at FIG. 7.

Turning now briefly to FIG. 8B, datasets employed for training an untrained/untuned analytical model 215 can comprise hundreds, thousands, or even tens of thousands of known analyte chromatography datasets (e.g., sets of data from chromatograms). As an example, the datasets employed relative to FIGS. 4 to 7 were from approximately 5000 chromatograms. In one or more cases, only chromatograms with known analytes injected can be employed.

Overall, as a summary of all datasets employed for FIGS. 4 to 7, column type and set conditions combination was: [Column: Ion Pac AS19 4 mm×250 4 μm (Part number 083217), EG Eluent: 20 mM KOH (0 to 20 min), Flow Rate: 1 ml/min, Injection Volume: 10 μL, Oven Temperature: 30° C., detector sampling rate: 5 Hz]. Nine total analytes were present overall: Fluoride, Chlorite, Bromate, Chloride, Nitrite, Chlorate, Bromide, Nitrate and Sulfate. It is noted that some chromatograms did not contain all of these nine analytes. The distribution of analytes employed is illustrated at distribution graph 840 of FIG. 8B. Since Carbonate is present in the chromatograms as a contaminant, it is not used for identification.

Turning again back to FIG. 8A, in one or more cases, analyte auto identification training can be treated as a classical classification problem, such as where the features are extracted information from the peaks, and the target classes are the analyte identities. The input for the analytical model 215 can be the extracted peak from the chromatogram, e.g., all the data points making such peak (e.g., an array of data points) while the output is the peak's predicted identity, such as chloride or any other suitable analyte in the stored database (e.g., database 235).

Turning briefly to FIG. 8C and to the process flow 850 illustrated thereat, data processing of the training data 802A and testing data 802B can comprise a plurality of steps. As illustrated at FIG. 8C, these can comprise, but are not limited to, peak integration 854 based on an initial chromatogram/dataset 852, peak selection and/or reduction 856, and/or peak extraction, labeling and storage (grouped into 858).

For example, from the chromatograms, the peaks (or data array making up the peaks) can be extracted, and assigned their known identities. Peak integration is the technique that delineates the beginning and end of a peak from other data of a chromatogram. Various peak integration methods can be employed. One such option is to marque a set of data beyond a given noise level as a peak. Then, in order not to select contaminants such as carbonate, a threshold for peak height is applied. Since the peaks are known injected analytes, each peak is extracted, the leading and trailing data points are assigned values of zero, and the identity label can be added to the extracted peak data array. The data processing for data post deployment will not have the added identifying elements to it since for the target peaks the identity would not be known. One or more additional steps can comprise discarding undesired chromatograms, such as those with a wrong number of expected peaks.

That is, relative to FIGS. 8A and 8C, each of the testing data 802B and the training data 802A can be processed (e.g., data processing 804A and 804B, respectively), including cleaning (e.g., removal of data noise 261), data augmentation and/or feature extraction. Removal of data noise 261 can comprise such removal based on a peak minimum height criterion for the testing data 802B and the training data 802A. Feature extraction can comprise recognition of separate peaks 260 of the testing data 802B and the training data 802A, which can be accomplished using image recognition of chromatograms generated therefrom, or via identifying of local minimas (e.g., of conductivity) along the time-labeled data. These local minimas can be the breaks between separate peaks 260.

In one or more cases, data processing further can comprise data splitting. That is, an overall data set can be split into the training data 802A, evaluation data 802E and testing data 802B prior to and/or after the other data processing steps (e.g., peak integration 854 based on an initial chromatogram/dataset 852, peak selection and/or reduction 856).

Relative to the datasets employed that correspond to FIGS. 4 to 7, such chromatograms comprised approximately 15,349 peaks. About 12% of total was set aside as test data set 802B, about 12% for an evaluation data set 802E and about 76% for a training data set 802A. In cases where there is insufficient data, augmented data techniques can be used. Although, no data augmentation was applied relative to FIGS. 4 to 7.

Discussion now turns to model training at FIG. 8A.

First, it is noted that various types of analytical models 216 (e.g., which first can be untuned/untrained models 215) can be employed. As noted above, an analytical model, such as an AI model or machine learning model, employed herein can comprise any one or more types of analytical model 216 including, but not limited to, a neural network, directed neural network, convoluted neural network, k-nearest neighbors classifier, language model, gradient boosting, logistic regression, scikit-learn (sklearn) and/or sklearn gradient boosting. One or more types of analytical model 216 can therefore be trained by the training component 214 and/or chromatography data analysis system 202, allowing for one or more types of trained analytical model 216 to be employed for analysis of a same target analyte chromatography dataset 256, or different target analyte chromatography datasets 256, during later execution stages.

One such non-limiting, example analytical model can be and/or can comprise a convoluted neural network (CNN), such as having 85.67% accuracy, using input features of extracted peak data array, having a target of identification, and comprising a data array converted into a spectrogram (e.g., 2D data in the frequency domain). Various processes of the CNN can comprise, but are not limited to a convolution layer, pooling layer, drop out, convolution layer, pooling layer, flattening, dense layer and classification.

Another such non-limiting, example analytical model can comprise a gradient boosting model, such as using decision trees, logistic regression, naïve bayes and/or random forest, without being limited thereto. Input features can comprise extracted peak data array, the analytical model can have a target of identification, and the analytical model can comprise a data array converted into a spectrogram (e.g., 2D data in the frequency domain). Various processes of such an analytical model can comprise flattening, principle component analysis (optional), gradient boosting and classification.

Yet another such non-limiting, example analytical model can employ gradient boosting at 98.21% accuracy and/or employ any other base classification model. Input features can comprise extracted peak data array, the model can have a target of identification, and the analytical model can comprise a data array converted into a spectrogram (e.g., 2D data in the frequency domain). Retention time can be set as a first feature. Additional processes can comprise moving all peaks such that the peaks'apexes align at a given nth occurrence (e.g., to capture the shape characteristic of a peak, gradient boosting and classification).

Still another example, non-limiting, analytical model type can be and/or comprise a logistic regression model.

A further example, non-limiting, analytical model type can be and/or comprise a k-nearest neighbors (KNN) classifier.

Yet another example, non-limiting, analytical model type can be and/or comprise a scikit-learn (sklearn) gradient boosting model.

Tuning 807 can comprise selection and identification of model hyperparameters 820, trained identification of peaks as corresponding to particular analytes resulting in output 822, evaluation 824 and weight updating 826. Evaluation 824 can comprise user entity feedback (e.g., using a computing device that is communicatively couplable to the non-limiting system 200) and/or direct comparison of output of training data 802A to testing data 802B. Weight updating 826 can comprise updating of various model performance metrics, such as accuracy metrics, error metrics, etc., without being limited thereto.

For example, a goal of the training can be to train an untuned model 215, but very often because the models tend to overfit, the accuracy numbers from the training data sets can be almost always 100%. The evaluation data 802E can thus be used to quickly assess an analytical model 215. The model accuracy numbers from the evaluation data 802E tend to be lower. As such, hyperparameters 820 within a trained, but untuned model 215 can be tuned to improve the accuracy numbers of the evaluation data set 802E. The test data set 802B can be used to assess how the trained, and tuned model 216 will perform with brand new data set. A resulting accuracy from the test data set 802B can be used to gauge a trained, and tuned analytical model. In addition, to prevent data leaking, the analytical model 215 can be tuned (e.g., tuning 807) other than on the evaluation data set output alone or training data set output alone. This can be performed to avoid an analytical model 216 seemingly performing well during testing, but inversely performing poorly when deployed with an end user entity.

Accordingly, still referring to FIGS. 2 and 8A, direction next turns to a set of execution processes 820 for using a tuned analytical model 216. Generally, a set of steps can comprise extracting peaks from chromatograms using the peak integration method or any other peak integration method, assigning the leading and trailing data points of peaks the values of zero, feeding the data array as input into the tuned analytical model 216 of choice, and then obtaining the predicted identification 266.

As noted above, and as part of this set of processes for using a tuned analytical model 216, this set of execution processes 802 that can be performed by the non-limiting system 200 can comprise executing of a comparison 264 using the trained analytical model 216 (e.g., tuned model).

For example, the obtaining component 210 can generally acquire (e.g., obtain, locate, identify, request, download, etc.) the target analyte chromatography data 256 and/or known analyte chromatography data 286, 290 and other known analyte chromatography data as employed by the one or more trained analytical models 216.

Referring still to FIGS. 2 and 8A, using the target analyte chromatography data 256 acquired, the reducing component 212 can perform one or more processes of data processing. This can comprise removal of data noise 261, data augmentation and/or feature extraction, without being limited thereto.

Feature extraction can comprise recognition of separate peaks 260 of the target analyte chromatography data 256, which can be accomplished using image recognition of chromatograms generated therefrom, or via identifying of local minimas (e.g., of conductivity) along the time-labeled data. These local minimas can be the breaks between separate peaks 260. In one or more cases, feature extraction described here, above and/or below can comprise use of principal component analysis (PCA) to reduce overfitting by reducing larger variables, resulting in smaller uncorrelated variables and/or linear combinations of the original variables. This can result in reducing of dimensions of the target analyte chromatography data 256 while maintaining the information defined by the target analyte chromatography data 256.

Additionally, and/or alternatively, feature extraction can comprise use of spectrograms to transform time series data (which can be multidimensional) into two-dimensional data, such as for use by a convoluted neural network model 216. As used herein, a spectrogram can comprise data of frequency content of a signal over time.

Removal of data noise 261 by the reducing component 212 can comprise such removal based on a peak minimum height criterion 263 for the peaks 260. The peak minimum height criterion 263 can be auto-selected by the system 202 and/or identified by a user entity, such as using a computing device that is communicatively couplable to the non-limiting system 200/system 202.

A next step can comprise selection of one or more trained analytical models 216 to employ for the comparison 264 of the target analyte chromatography data 256 to known analyte chromatography data 286, 290 and other known analyte chromatography data as employed by the one or more trained analytical models 216. This selection can be performed by the training component 214 (in an execution phase, rather than training phase), and/or by the processor 206.

As noted above, an analytical model 216, such as an AI model or machine learning model, employed herein can comprise any one or more types of analytical model including, but not limited to, a neural network, directed neural network, convoluted neural network, k-nearest neighbors classifier, language model, gradient boosting, logistic regression, scikit-learn (sklearn) and/or sklearn gradient boosting.

In one or more embodiments, considerations for a selected analytical model can be at least partially based on an accuracy threshold requested by a customer/end user entity and/or at least partially based on computational resources available for inference at the non-limiting system 200.

One or more trained analytical models 216 can be employed, such as at least partially in parallel with one another, to compare target analyte chromatography data 256 and known analyte standard chromatography data 186, 290 and/or other and/or to identify one or more analytes 259 (e.g., as identified target analytes 259T) corresponding to one or more respective peaks 260 (e.g., target peaks 260T) of the target analyte chromatography data 256. In one or more cases, a particular target peak 260T can be identified, such as by a user entity (e.g., using a computing device communicatively couplable to the non-limiting system 200), for which identification of a target analyte 259T is desired and/or requested.

It is noted that each single trained analytical model 216 (also referred to herein as a tuned model 216) selected can be employed to identify one or more target peaks 260T, such as all or less than all peaks 260 of a set of target analyte chromatography data 256.

In one or more embodiments, the trained analytical model 216 can comprise the comparing component 217 and/or identifying component 220. In one or more other embodiments, the comparing component 217 and/or identifying component 220 can be separate from the analytical model 216.

That is, generally, the trained analytical model 216 (e.g., each trained analytical model 216 selected, either separately or at least partially in parallel with one another) can execute a comparison 264 of a first value of the target characteristic 257T of the target peak 260T (e.g., a peak 260 identified for identification 266) to a second value of a known characteristic 288, 292 of the respective known analyte chromatography data 286, 290.

For example, in particular, turning now to the comparing component 217, this component can generally execute a comparison of a target characteristic 257T of target analyte chromatography data 256 to a known characteristic 288, 292 of known analyte chromatography data 286, 290, where the known characteristic 288, 292 comprises a deviation 262 relative to one or more other known characteristics 288, 292. It is noted that one or more characteristics 257 can be identified with any one or more being selected (e.g., automatically by the comparing component 217) as a target characteristic 257T.

As noted above, a deviation 262 can comprise a position shift and/or shape shift of a peak 260 of known analyte chromatography data to other known analyte chromatography data.

Additionally, and/or alternatively, a deviation 262 can be based on a chromatography column to chromatography column variation, chromatography instrument to chromatography instrument variation, column life cycle, or analyte concentration to analyte concentration variation.

A comparison 264 can generally indirectly employ a deviation 262. That is the analytical model 216 can identify and/or employ a difference between the target characteristic 257T and the known characteristic 288, 292 to thereby identity the target peak 260T based on identification of one or more learned and/or recognized patterns that re based on the aforementioned training (e.g., as illustrated at FIG. 8A) comprising data (e.g., testing data 802B and training data 802A) employing a plurality of different deviations relative to a plurality of different known analyte chromatography datasets.

Discussion next turns to a third set of processes for executing the identification 266 based on the comparison 264 and using the trained analytical model 216.

That is, based on an output of the comparison 264, such as a pattern based on data comprised by a target peak 260T and/or peak 260 of known analyte chromatography data 286, 290, the identifying component 220 can execute an identification 266 of a target analyte 259T corresponding to a target peak 260T of a target chromatogram 258T, corresponding to the target analyte chromatography data 256. As noted, this can be at least partially (e.g., indirectly) based on the deviation 262. That is, the identifying component 220 identifies the analyte 259T based at least on the comparison 264.

In one or more embodiments, the isolating component 224 can target peak data 255 corresponding to the target peak 260T from other peak data corresponding to other peaks 260 of the target analyte chromatography data 256. The isolating component 224 can label the target peak data 255 with a label 293 according to the identification 266 and resulting in a labeled target peak 260L (and/or data thereof). Further, the isolating component 224 can store the respective labeled target peak data 260L separately from the other data corresponding to the other peaks 260 of the target chromatogram 258T and/or target analyte chromatography data 256. For example, storage can be at the library datastore 235. This storage can allow for use of the labeled target peak data 260L for future identifications 266, trainings 806, tunings 807, etc.

In one or more embodiments, the notifying component 222 can generate a notification 298 comprising a result of the comparison 264, a result of the identification 266 and/or a peak identification reasoning 268. For example, based on an employed data pattern (e.g., learned data pattern resulting from training 806 and/or tuning 807), a correlation can be determined and reported (e.g., as data in any suitable form) describing at least a partial reasoning for the identification 266 of the target peak 260T. This can provide at least some information to an end user entity based on what often can be a closed-box process of an analytical model.

In one or more embodiments, the identifying component 220 can facilitate a feedback evaluation 808 (FIG. 8A) relative to the identification 266.

As a summary of the above-described components and/or functions thereof, the one or more embodiments described herein can result in a plurality of benefits.

This can include multivariate analysis. For example, existing chromatographic methods can focus heavily on retention time for analyte identification. Analytical models, such as ML models, can integrate multiple features, such as peak shape, area and/or intensity, to create a robust framework that withstands retention time variability.

Another benefit can comprise recognition of complex patterns. That is, analytical models, such s deep learning models, including CNNs, can excel at detecting nonlinear relationships in data. This capability can allow an analytical model to classify analytes based on intricate patterns in chromatographic signals, including peak shape and signal intensity, reducing the likelihood of misinterpretation.

Another benefit can comprise robustness against retention time shifts. By training models on data reflecting diverse variations, a model learn to identify analytes using more reliable attributes. This can restrict and/or eliminate a dependency on fixed retention times.

Still another benefit can comprise data augmentation and adaptive learning. That is, analytical models, such as ML models, can continuously improve through adaptive learning, incorporating new chromatographic data to enhance predictive accuracy. This adaptability can provide for consistent performance despite variations in experimental conditions, such as column aging or mobile phase changes.

Another benefit can comprise reduced calibration requirements. Indeed, the one or more embodiments described herein can reduce exhaustive calibrations with known analytes to establish peak identity. Once trained, an analytical model can classify and identify unknown analytes from new samples, even under varying conditions.

Still another benefit can comprise integration with advanced detection techniques. That is, when coupled with advanced detection methods (e.g., mass spectrometry, UV-Vis spectroscopy, conductivity detectors), ML can cross-validate results, improving identification accuracy and reducing reliance on retention time alone.

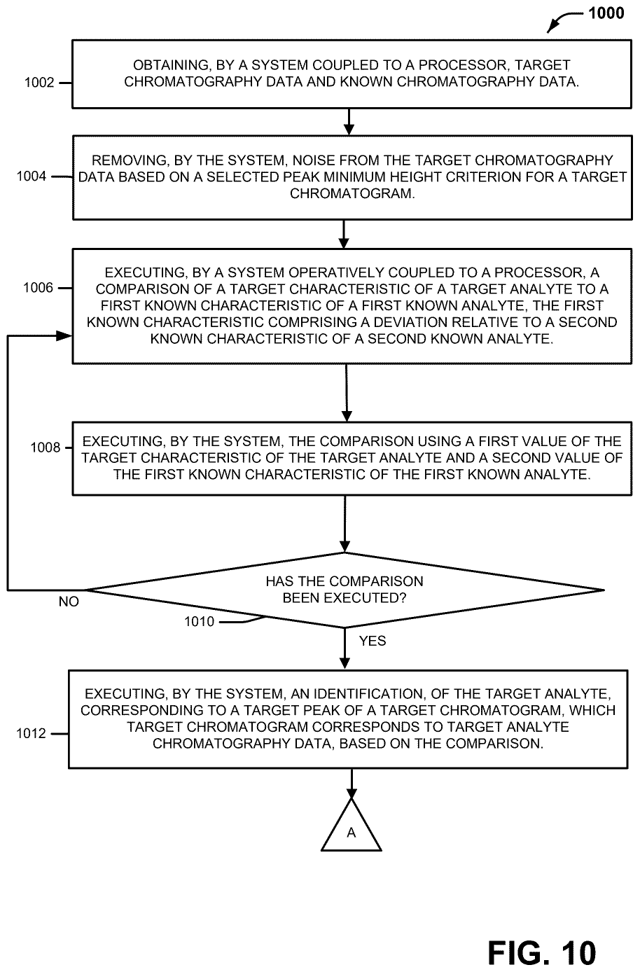

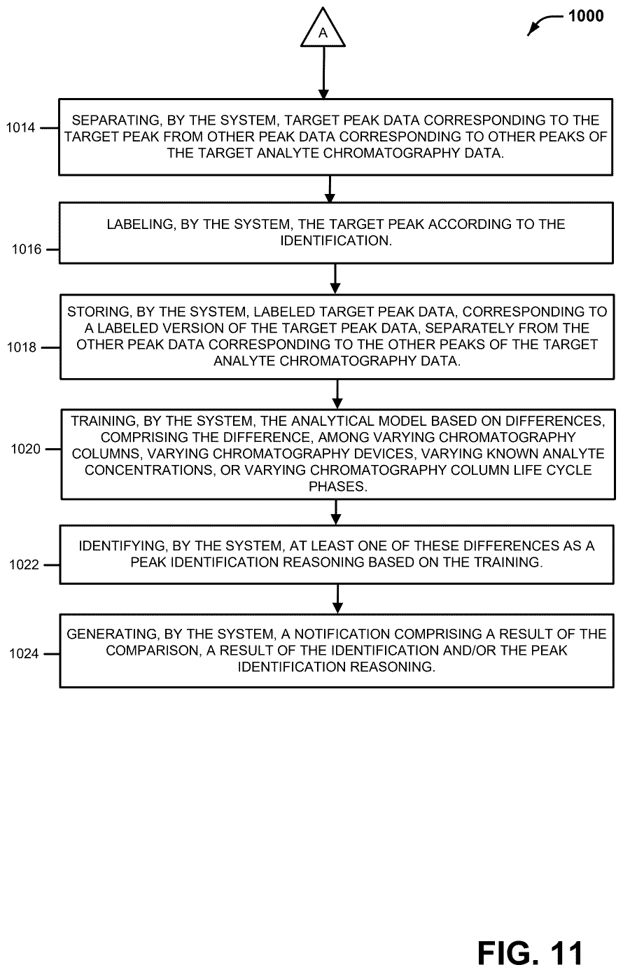

As another summary of the above-described components and/or functions thereof, referring next to FIGS. 10 and 11, illustrated is a flow diagram of an example, non-limiting method 1000 that can facilitate a process for chromatography data comparison and eluted analyte identification, in accordance with one or more example embodiments described herein, such as the non-limiting system 200 of FIG. 2. While the non-limiting method 1000 is described relative to the non-limiting system 200 of FIG. 2, the non-limiting method 1000 can be applicable also to other systems described herein, such as the non-limiting system of FIG. 1. Repetitive description of like elements and/or processes employed in respective embodiments is omitted for sake of brevity.

At 1002, the non-limiting method 1000 can comprise obtaining, by a system (e.g., obtaining component 210) target analyte chromatography data (e.g., target analyte chromatography data 256) and known analyte chromatography data (e.g., known analyte chromatography data 286, 290).

At 1004, the non-limiting method 1000 can comprise removing, by the system (e.g., reducing component 212), noise (e.g., noise 261) from the target analyte chromatography data based on a peak minimum height criterion (e.g., peak minimum height criterion 263) for a target chromatogram (e.g., target chromatogram 258T).

At 1006, the non-limiting method 1000 can comprise executing, by the system (e.g., comparing component 217 and/or analytical model 216), a comparison (e.g., comparison 264) of a target characteristic (e.g., target characteristic 257T) of a target analyte (e.g., target analyte 259T) to a first known characteristic (e.g., first known characteristic 286) of a first known analyte (e.g., first known analyte 287), the first known characteristic comprising a deviation (e.g., deviation 162) relative to a second known characteristic (e.g., second known characteristic 292) of a second known analyte (e.g., second known analyte 291).

At 1008, executing the comparison of the non-limiting method 1000 can comprise using, by the system (e.g., comparing component 217 and/or analytical model 216), a first value of the target characteristic of the target analyte and a second value of the first known characteristic of the first known analyte.

At 1010, the non-limiting method 1000 can comprise determining, by the system, (e.g., identifying component 220 and/or analytical model 216), whether the comparison has been executed. If yes, the non-limiting method 1000 can proceed to step 1012. If not, the non-limiting method 1000 can proceed back to step 1006.

At 1012, the non-limiting method 1000 can comprise executing, by the system (e.g., identifying component 220 and/or analytical model 216), an identification (e.g., identification 266), of the target analyte, corresponding to a target peak (e.g., target pea, 260T) of a target chromatogram (e.g., target chromatogram 258T), which target chromatogram corresponds to target analyte chromatography data (e.g., target analyte chromatography data 256), based on the comparison.

That is, the identifying component 218 can identify the target analyte 259T based on the comparison 264 of the target analyte chromatography data 256 to the known analyte chromatography data 286, 290, such as of the target characteristic 257T to the first known characteristic 288.

At 1014, the non-limiting method 1000 can comprise separating, by the system (e.g., isolating component 224), target peak data (e.g., target peak data 255) corresponding to the target peak (e.g., target peak 260T) from other peak data corresponding to other peaks of the target analyte chromatography data.

At 1016, the non-limiting method 1000 can comprise labeling, by the system (e.g., isolating component 224), the target peak according to the identification (e.g., with a label 293).

At 1018, the non-limiting method 1000 can comprise storing, by the system (e.g., isolating component 224), labeled target peak data (e.g., labeled target peak data 260L), corresponding to a labeled version of the target peak data (e.g., target peak data 255), separately from the other peak data corresponding to the other peaks of the target analyte chromatography data.

At 1020, the non-limiting method 1000 can comprise training, by the system (e.g., training component 214), the analytical model (e.g., analytical model 216) on differences, comprising the difference, among varying chromatography columns, varying chromatography devices, varying known analyte concentrations, or varying chromatography column life cycle phases.

At 1022, the non-limiting method 1000 can comprise identifying, by the system (e.g., analytical model 216 and/or identifying component 220), at least one of these differences as a peak identification reasoning (e.g., peak identification reasoning 268) based on the training (e.g., training 806).

At 1024, the non-limiting method 1000 can comprise generating, by the system (e.g., notifying component 222), a notification (e.g., notification 298) comprising a result of the comparison, a result of the identification and/or the peak identification reasoning.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, embodiments described herein relate to analysis of chromatography data. A system can comprise a memory 104, 204 that stores, and a processor 106, 206 that executes, computer executable components. The computer executable components can comprise a comparing component 117, 217 of an analytical model 116, 216 that executes a comparison 164, 264 of a target characteristic 157T, 257T of a target analyte 159T, 259T to a first known characteristic 188, 288 of a first known analyte 187, 287, the first known characteristic 188, 288 comprising a deviation 162, 262 relative to a second known characteristic 192, 292 of a second known analyte 191, 291, and an identifying component 120, 220, of the analytical model 116, 216, that executes an identification 166, 266, of the target analyte 159T, 259T, corresponding to a target peak 160T, 260T of a target chromatogram 158T, 258T, which target chromatogram 158T, 258T corresponds to target analyte chromatography data 156 256, based on the comparison 164, 264.

The one or more example embodiments disclosed herein can be applied on a plug-and-play basis to a measurement instrument, plural measurement instruments, a same measurement instrument using plural exchangeable components (e.g., columns), etc. for calibration, normalization and/or comparison of output data relative to unknown, known and/or standard analyte chromatography data. As used herein, known analyte chromatography data can comprise and/or be standard analyte chromatography data. The frameworks described herein can be performed in a time efficient and at least partially automatic manner, thereby increasing instrument use time and/or reducing user entity interaction for pre-experiment and/or post-experiment processes. In one or more cases, identification data obtained from use of the one or more example embodiments can be employed to construct a database of known analyte chromatography data.

Accordingly, the one or more example embodiments described herein can be implemented within, in connection with and/or coupled to a scientific measurement instrument, such as a chromatography instrument.

Indeed, in view of the one or more example embodiments described herein, a practical application of the one or more systems, computer-implemented methods and/or computer program products described herein can be an ability to employ deviations of characteristics between different known analyte chromatography datasets. These deviations can be caused by different instruments, different columns, different elution times, aging of a column, different analyte concentrations, etc., without being limited thereto. The characteristics that can be exhibited due to the deviations can be of the chromatography data that resolve as characteristics of a chromatogram generated from the chromatography data. For example, a characteristic can comprise a shift in a peak along an x-axis (elution time axis), a shift in a peak along a y-axis (conductivity axis), a shift in a shape of a peak, a change in a range of elution time, etc. Deviations can be employed indirectly, such as training one or more neurons and/or layers of an analytical model on known analyte chromatography data comprising deviations and/or deviation characteristics, in connection with one or more peak identities and/or peak characteristics of the known analyte chromatography data.

As compared to existing frameworks that cannot provide these abilities, the one or more example embodiments described herein can employ the one or more trained neurons and/or layers of one or more analytical models to identify target peaks of target analyte chromatography data based on learned known characteristics of the known analyte chromatography data. This can enable identification of target peaks and thus target analytes even in view of variations of different target analyte chromatography datasets for a same target analyte. These identifications can be accomplished employing a database of hundreds, thousands, tens of thousands, or more known analyte chromatography datasets, labeled peaks, etc., without being limited thereto, upon which the one or more analytical models can trained and/or employ.

These are useful and practical applications of computers and/or analytical models, thus providing enhanced (e.g., improved and/or optimized) analyte identification. Overall, such tools can constitute a concrete and tangible technical improvement in the fields of material analysis, and more particularly in analysis of scientific measurement instrument output, such as including, but not limited to, the field of chromatography.

Furthermore, one or more example embodiments described herein can be employed in a real-world system based on the disclosed teachings. For example, one or more embodiments described herein can indirectly employ the one or more deviations, as described above, to identify target peaks of target analytes relative to/using corresponding peaks of known analyte chromatography data. For example, an identification can be employed to accurately verify quality of a product, accurately determine a location to drill, and/or accurately purchase chemical recipe components, even in view of variations of different target analyte chromatography datasets for a same target analyte. The embodiments disclosed herein thus can provide improvements to scientific instrument technology (e.g., improvements in the computer technology supporting such scientific instruments, among other improvements).

Moreover, the one or more example embodiments described herein can achieve a level of scale of operation. For example, chromatography data corresponding to two or more compounds can be evaluated at least partially in parallel with one another relative to same and/or different instruments, columns, and/or analyte concentrations.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more example embodiments described herein can be, in one or more cases, inherently and/or inextricably tied to computer technology and cannot be implemented outside of a computing environment. For example, one or more processes performed by one or more example embodiments described herein can more efficiently, and even more feasibly, provide program and/or program instruction execution, such as relative to measurement instrument output analysis (e.g., measurement instrument use for material analysis), as compared to existing systems and/or techniques for addressing variations between outputs using a same target analyte. Systems, computer-implemented methods and/or computer program products providing performance of these processes are of great utility in the fields of material analysis and cannot be equally practicably implemented in a sensible way outside of a computing environment.

One or more example embodiments described herein can employ hardware and/or software to solve problems that are highly technical, that are not abstract, and that cannot be performed as a set of mental acts by a human. For example, a human, or even thousands of humans, cannot efficiently, accurately and/or effectively analyze computer data/metadata (e.g., defining chromatography data) defining eluted analyte conductivity vs. elution time analyzed at one or more measurement instruments, and/or generate a digital display visual of quantified similarities and/or differences between chromatography datasets, as the one or more example embodiments described herein can provide this process. Moreover, neither can the human mind nor a human with pen and paper conduct one or more of these processes, as conducted by one or more example embodiments described herein.

In one or more example embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more example embodiments described herein and/or components thereof can be employed to solve new problems that arise through advancements in technologies mentioned above, employment of quantum computing systems, cloud computing systems, computer architecture and/or another technology.

One or more example embodiments described herein can be fully operational towards performing one or more other functions (e.g., fully powered on, fully executed and/or another function) while also performing one or more of the one or more operations described herein.

To provide additional summary, a listing of embodiments and features thereof is next provided.

A system, comprising: a memory that stores computer executable components; and a processor that executes the computer executable components stored in the memory, wherein the computer executable components comprise: a comparing component, of an analytical model, that executes a comparison, of a target characteristic of a target analyte to a first known characteristic of a first known analyte, the first known characteristic comprising a deviation relative to a second known characteristic of a second known analyte; and an identifying component, of the analytical model, that executes an identification of the target analyte corresponding to a target peak of a target chromatogram, which target chromatogram corresponds to target analyte chromatography data, based on the comparison.

The system of the preceding paragraph, wherein the comparison is based on the deviation comprised by the first known analyte, wherein the computer executable components further comprise: the analytical model that is trained on a difference between the first known analyte and the second known analyte, the difference correlating to the deviation.

The system of any preceding paragraph, wherein the analytical model executes the comparison using a first value of the target characteristic of the target analyte and a second value of the first known characteristic of the first known analyte.

The system of any preceding paragraph, wherein the computer executable components further comprise: a training component that trains the analytical model based on differences, comprising the difference, among varying chromatography columns, varying chromatography instruments, varying known analyte concentrations, or varying chromatography column life cycle phases.

The system of any preceding paragraph, wherein the computer executable components further comprise: a reducing component that removes noise from the target analyte chromatography data based on a peak minimum height criterion for the target analyte chromatography data.

The system of any preceding paragraph, wherein the analytical model is trained on the deviation comprising a position shift or a shape shift of a first peak of first known analyte chromatography data, corresponding to the first known analyte, as compared to a second peak of second known analyte chromatography data, corresponding to the second known analyte, along a time axis.

The system of any preceding paragraph, wherein the identifying component identifies the target peak based on a training of the analytical model in connection with the deviation.

The system of any preceding paragraph, wherein the computer executable components further comprise: an isolating component that separates target peak data corresponding to the target peak from other peak data corresponding to other peaks of the target analyte chromatography data, labels the target peak data according to the identification, and stores labeled target peak data, corresponding to a labeled version of the target peak data, separately from the other peak data corresponding to the other peaks of the target analyte chromatography data.

A computer-implemented method, comprising: executing, by an analytical model of a system operatively coupled to a processor, a comparison, of a target characteristic of a target analyte to a first known characteristic of a first known analyte, the first known characteristic comprising a deviation relative to a second known characteristic of a second known analyte; and executing, by the analytical model of the system, an identification of the target analyte corresponding to a target peak of a target chromatogram, which target chromatogram corresponds to target analyte chromatography data, based on the comparison.

The computer-implemented method of the preceding paragraph, wherein the comparison is based on the deviation comprised by the first known analyte, and wherein the analytical model is trained on a difference between the first known analyte and the second known analyte, the difference correlating to the deviation.

The computer-implemented method of any preceding paragraph, further comprising: executing, by the analytical model of the system, the comparison using a first value of the target characteristic of the target analyte and a second value of the first known characteristic of the first known analyte.

The computer-implemented method of any preceding paragraph, further comprising: training, by the system, the analytical model based on differences, comprising the difference, among varying chromatography columns, varying chromatography instruments, varying known analyte concentrations, or varying chromatography column life cycle phases.

The computer-implemented method of any preceding paragraph, further comprising: removing, by the system, noise from the target analyte chromatography data based on a peak minimum height criterion for the target analyte chromatography data.

The computer-implemented method of any preceding paragraph, wherein the analytical model is trained on the deviation comprising a position shift or a shape shift of a first peak of first known analyte chromatography data, corresponding to the first known analyte, as compared to a second peak of second known analyte chromatography data, corresponding to the second known analyte, along a time axis.

The computer-implemented method of any preceding paragraph, further comprising: separating, by the system, target peak data corresponding to the target peak from other peak data corresponding to other peaks of the target analyte chromatography data; labeling, by the system, the target peak data according to the identification; and storing, by the system, labeled target peak data, corresponding to a labeled version of the target peak data, separately from the other peak data corresponding to the other peaks of the target analyte chromatography data.

A computer program product facilitating a process for chromatogram peak identification, the computer program product comprising a computer readable storage medium having program instructions embodied therewith, and the program instructions executable by a processor to cause the processor to: execute, by the processor using an analytical model, a comparison, of a target characteristic of a target analyte to a first known characteristic of a first known analyte, the first known characteristic comprising a deviation relative to a second known characteristic of a second known analyte; and execute, by the processor, using the analytical model, an identification of the target analyte corresponding to a target peak of a target chromatogram, which target chromatogram corresponds to target analyte chromatography data, based on the comparison.

The computer program product of the preceding paragraph, wherein the comparison is based on the deviation comprised by the first known analyte, and wherein the analytical model is trained on a difference between the first known analyte and the second known analyte, the difference correlating to the deviation.

The computer program product of any preceding paragraph, wherein the program instructions are further executable by the processor to cause the processor to:
execute, by the processor using the analytical model, the comparison using a first value of the target characteristic of the target analyte and a second value of the first known characteristic of the first known analyte.

The computer program product of any preceding paragraph, wherein the program instructions are further executable by the processor to cause the processor to:
train, by the processor, the analytical model based on differences, comprising the difference, among varying chromatography columns, varying chromatography instruments, varying known analyte concentrations, or varying chromatography column life cycle phases.

The computer program product of any preceding paragraph, wherein the program instructions are further executable by the processor to cause the processor to:
separate, by the processor, target peak data corresponding to the target peak from other peak data corresponding to other peaks of the target analyte chromatography data; label, by the processor, the target peak data according to the identification; and store, by the processor, labeled target peak data, corresponding to a labeled version of the target peak data, separately from the other peak data corresponding to the other peaks of the target analyte chromatography data.

### Example Operating Environment

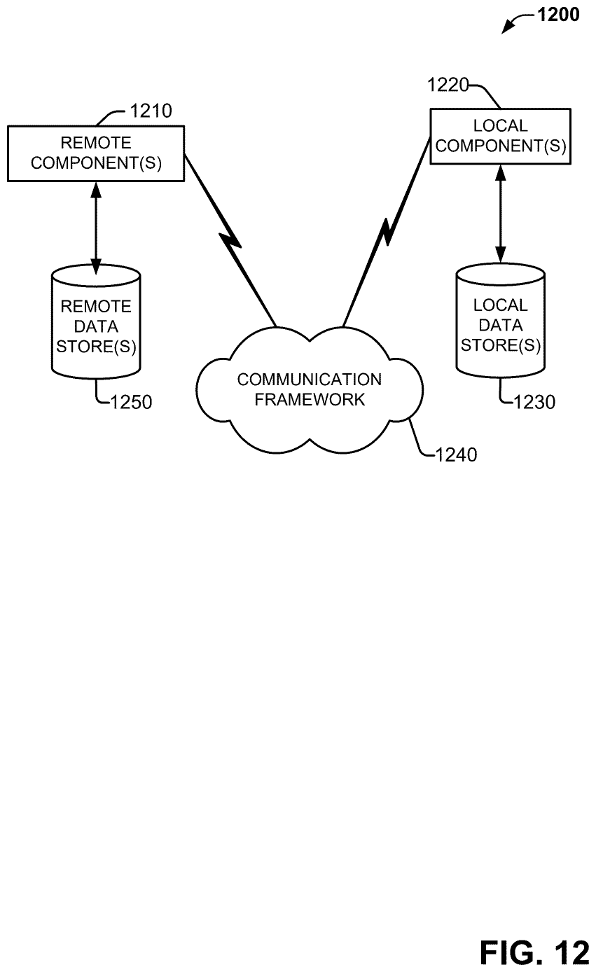

FIG. 12 is a schematic block diagram of an operating environment 1200 with which the described subject matter can interact. The operating environment 1200 comprises one or more remote component(s) 1210. The remote component(s) 1210 can be hardware and/or software (e.g., threads, processes, computing devices). In one or more example embodiments, remote component(s) 1210 can be a distributed computer system, connected to a local automatic scaling component and/or programs that use the resources of a distributed computer system, via communication framework 1240. Communication framework 1240 can comprise wired network devices, wireless network devices, mobile devices, wearable devices, radio access network devices, gateway devices, femtocell devices, servers, etc.

The operating environment 1200 also comprises one or more local component(s) 1220. The local component(s) 1220 can be hardware and/or software (e.g., threads, processes, computing devices). In one or more example embodiments, local component(s) 1220 can comprise an automatic scaling component and/or programs that communicate/use the remote resources 1210 and 1220, etc., connected to a remotely located distributed computing system via communication framework 1240.

One possible communication between a remote component(s) 1210 and a local component(s) 1220 can be in the form of a data packet adapted to be transmitted between two or more computer processes. Another possible communication between a remote component(s) 1210 and a local component(s) 1220 can be in the form of circuit-switched data adapted to be transmitted between two or more computer processes in radio time slots. The operating environment 1200 comprises a communication framework 1240 that can be employed to facilitate communications between the remote component(s) 1210 and the local component(s) 1220, and can comprise an air interface, e.g., interface of a UMTS network, via an LTE network, etc. Remote component(s) 1210 can be operably connected to one or more remote data store(s) 1250, such as a hard drive, solid state drive, subscriber identity module (SIM) card, electronic SIM (eSIM), device memory, etc., that can be employed to store information on the remote component(s) 1210 side of communication framework 1240. Similarly, local component(s) 1220 can be operably connected to one or more local data store(s) 1230, that can be employed to store information on the local component(s) 1220 side of communication framework 1240.

### Example Computing Environment

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform tasks or implement abstract data types. Moreover, the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Referring still to FIG. 13, the example computing environment 1300 which can implement one or more example embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), and can include one or more external storage devices 1316 (e.g., a magnetic floppy disk drive (FDD) 1316, a memory stick or flash drive reader, a memory card reader, etc.). While the internal HDD 1314 is illustrated as located within the computer 1302, the internal HDD 1314 can also be configured for external use in a suitable chassis (not shown). Additionally, while not shown in computing environment 1300, a solid-state drive (SSD) could be used in addition to, or in place of, an HDD 1314.

Other internal or external storage can include at least one other storage device 1320 with storage media 1322 (e.g., a solid-state storage device, a nonvolatile memory device, and/or an optical disk drive that can read or write from removable media such as a CD-ROM disc, a DVD, a BD, etc.). The external storage 1316 can be facilitated by a network virtual machine. The HDD 1314, external storage device 1316 and storage device (e.g., drive) 1320 can be connected to the system bus 1308 by an HDD interface 1324, an external storage interface 1326 and a drive interface 1328, respectively.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the . NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user entity can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera, a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can also be connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer 1350. The remote computer 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. The network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a defined structure as with an existing network or simply an ad hoc communication between at least two devices.

### Additional Information

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more example embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more example embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more example embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more example embodiments described herein.

Aspects of the one or more example embodiments described herein are described with reference to flowchart illustrations and/or block diagrams of methods, apparatus (systems), and computer program products according to one or more example embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more example embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more example embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more example embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more example embodiments, but one of ordinary skill in the art can recognize that many further combinations and/or permutations of the one or more example embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments can use the phrases “an embodiment,” “various embodiments,” “one or more example embodiments” and/or “some embodiments,” each of which can refer to one or more of the same or different embodiments.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor that executes the computer executable components stored in the memory, wherein the computer executable components comprise:
a comparing component, of an analytical model, that executes a comparison, of a target characteristic of a target analyte to a first known characteristic of a first known analyte, the first known characteristic comprising a deviation relative to a second known characteristic of a second known analyte; and
an identifying component, of the analytical model, that executes an identification, of the target analyte, corresponding to a target peak of a target chromatogram, which target chromatogram corresponds to target analyte chromatography data, based on the comparison.

2. The system of claim 1,
wherein the comparison is based on the deviation comprised by the first known analyte,
wherein the computer executable components further comprise:
the analytical model that is trained on a difference between the first known analyte and the second known analyte, the difference correlating to the deviation.

3. The system of claim 2,
wherein the analytical model executes the comparison using a first value of the target characteristic of the target analyte and a second value of the first known characteristic of the first known analyte.

4. The system of claim 1, wherein the computer executable components further comprise:
a training component that trains the analytical model based on differences, comprising the difference, among varying chromatography columns, varying chromatography instruments, varying known analyte concentrations, or varying chromatography column life cycle phases.

5. The system of claim 1, wherein the computer executable components further comprise:
a reducing component that removes noise from the target analyte chromatography data based on a peak minimum height criterion for the target analyte chromatography data.

6. The system of claim 2, wherein the analytical model is trained on the deviation comprising a position shift or a shape shift of a first peak of first known analyte chromatography data, corresponding to the first known analyte, as compared to a second peak of second known analyte chromatography data, corresponding to the second known analyte, along a time axis.

7. The system of claim 6, wherein the identifying component identifies the target peak based on a training of the analytical model in connection with the deviation.

8. The system of claim 1, wherein the computer executable components further comprise:
an isolating component that separates target peak data corresponding to the target peak from other peak data corresponding to other peaks of the target analyte chromatography data,
labels the target peak data according to the identification, and
stores labeled target peak data, corresponding to a labeled version of the target peak data, separately from the other peak data corresponding to the other peaks of the target analyte chromatography data.

9. A computer-implemented method, comprising:
executing, by an analytical model of a system operatively coupled to a processor, a comparison, of a target characteristic of a target analyte to a first known characteristic of a first known analyte, the first known characteristic comprising a deviation relative to a second known characteristic of a second known analyte; and
executing, by the analytical model of the system, an identification, of the target analyte, corresponding to a target peak of a target chromatogram, which target chromatogram corresponds to target analyte chromatography data, based on the comparison.

10. The computer-implemented method of claim 9,
wherein the comparison is based on the deviation comprised by the first known analyte, and
wherein the analytical model is trained on a difference between the first known analyte and the second known analyte, the difference correlating to the deviation.

11. The computer-implemented method of claim 10, further comprising:
executing, by the analytical model of the system, the comparison using a first value of the target characteristic of the target analyte and a second value of the first known characteristic of the first known analyte.

12. The computer-implemented method of claim 9, further comprising:
training, by the system, the analytical model based on differences, comprising the difference, among varying chromatography columns, varying chromatography instruments, varying known analyte concentrations, or varying chromatography column life cycle phases.

13. The computer-implemented method of claim 9, further comprising:
removing, by the system, noise from the target analyte chromatography data based on a peak minimum height criterion for the target analyte chromatography data.

14. The computer-implemented method of claim 10, wherein the analytical model is trained on the deviation comprising a position shift or a shape shift of a first peak of first known analyte chromatography data, corresponding to the first known analyte, as compared to a second peak of second known analyte chromatography data, corresponding to the second known analyte, along a time axis.

15. The computer-implemented method of claim 9, further comprising:
separating, by the system, target peak data corresponding to the target peak from other peak data corresponding to other peaks of the target analyte chromatography data;
labeling, by the system, the target peak data according to the identification; and
storing, by the system, labeled target peak data, corresponding to a labeled version of the target peak data, separately from the other peak data corresponding to the other peaks of the target analyte chromatography data.

16. A computer program product facilitating a process for chromatogram peak identification, the computer program product comprising a computer readable storage medium having program instructions embodied therewith, and the program instructions executable by a processor to cause the processor to:
execute, by the processor using an analytical model, a comparison, of a target characteristic of a target analyte to a first known characteristic of a first known analyte, the first known characteristic comprising a deviation relative to a second known characteristic of a second known analyte; and
execute, by the processor, using the analytical model, an identification, of the target analyte, corresponding to a target peak of a target chromatogram, which target chromatogram corresponds to target analyte chromatography data, based on the comparison.

17. The computer program product of claim 16,
wherein the comparison is based on the deviation comprised by the first known analyte, and
wherein the analytical model is trained on a difference between the first known analyte and the second known analyte, the difference correlating to the deviation.

18. The computer program product of claim 17, wherein the program instructions are further executable by the processor to cause the processor to:
execute, by the processor using the analytical model, the comparison using a first value of the target characteristic of the target analyte and a second value of the first known characteristic of the first known analyte.

19. The computer program product of claim 17, wherein the program instructions are further executable by the processor to cause the processor to:
train, by the processor, the analytical model based on differences, comprising the difference, among varying chromatography columns, varying chromatography instruments, varying known analyte concentrations, or varying chromatography column life cycle phases.

20. The computer program product of claim 16, wherein the program instructions are further executable by the processor to cause the processor to:
separate, by the processor, target peak data corresponding to the target peak from other peak data corresponding to other peaks of the target analyte chromatography data;
label, by the processor, the target peak data according to the identification; and
store, by the processor, labeled target peak data, corresponding to a labeled version of the target peak data, separately from the other peak data corresponding to the other peaks of the target analyte chromatography data.
